(19) United States
(12) Patent Application Publication
(10) Pub. No.: US 2024/0379938 A1
(43) Pub. Date: Nov. 14, 2024

(54) CATHODES FOR HIGH VOLTAGE LITHIUM-ION SECONDARY BATTERY AND DRY METHOD FOR MANUFACTURE OF SAME

(71) Applicants: THE CHEMOURS COMPANY FC, LLC, WILMINGTON, DE (US); THE REGENTS OF THE UNIVERSITY OF CALIFORNIA, OAKLAND, CA (US)

(72) Inventors: YING SHIRLEY MENG, SAN DIEGO, CA (US); DENNIS J. KOUNTZ, WEST CHESTER, PA (US); BENJAMIN GOULD, WILMINGTON, DE (US); WEIKANG LI, BOLINGBROOK, IL (US); ALLISON SICHLER, NEWARK, DE (US); CRYSTAL K. WATERS, WILSON, NC (US); WEILIANG YAO, SAN DIEGO, CA (US); MINGHAO ZHANG, LA JOLLA, CA (US)

(73) Assignees: THE CHEMOURS COMPANY FC, LLC, WILMINGTON (DE); THE REGENTS OF THE UNIVERSITY OF CALIFORNIA, OAKLAND, CA (US)

(21) Appl. No.: 18/690,458

(22) PCT Filed: Sep. 8, 2022
(86) PCT No.: PCT/US2022/042823

§ 371 Date: Mar. 8, 2024

Related U.S. Application Data
(60) Provisional application No. 63/242,426, filed on Sep. 9, 2021.
(60) Provisional application No. 63/354,362, filed on Jun. 22, 2022.

(51) Int. Cl. H01M 4/131; H01M 4/02; H01M 4/04; H01M 4/1391; H01M 4/505; H01M 4/62; H01M 10/0525; H01M 10/0569

(52) U.S. Cl. CPC H01M 4/131; H01M 4/0404; H01M 4/0435; H01M 4/1391; H01M 4/505; H01M 4/623; H01M 4/625; H01M 10/0525; H01M 10/0569; H01M 2004/021; H01M 2004/028; H01M 2300/0034; H01M 2300/0037

(57) ABSTRACT

A cathode for a high voltage lithium-ion secondary battery is described, including: an electrode layer having an electrode composition containing cathode active particles, fluoropolymer binder and conductive carbon. The cathode active particles are high voltage lithium transition metal oxides, the fluoropolymer binder is a fibrillated tetrafluoroethylene polymer having high melt creep viscosity, and the conductive carbon is carbon fibers having a specific surface area of about 50 m²/g or less. The carbon fibers and the fluoropolymer binder form a conducting structural web electronically connecting the cathode active particles, enabling electronic conductivity through the electrode layer. The electrode layer is adhered to a current collector comprising aluminum having surface roughness and substantially no carbon surface coating other than the conductive carbon of the electrode layer. Further described is a dry binder process to fabricate such cathodes, and the utility of such cathodes in high voltage lithium-ion secondary batteries.

### CROSS REFERENCE TO RELATED APPLICATIONS

This application is a national filing under 35 U.S.C. 371 of International Application No. PCT/US2022/042823 filed Sep. 8, 2022, and claims the benefit of priority of U.S. Provisional Application No. 63/242,426 filed Sep. 9, 2021 and claims the benefit of priority of U.S. Provisional Application No. 63/354,362 filed Jun. 22, 2022, the disclosures of which are incorporated herein by reference in its entirety.

### FIELD

The present disclosure relates to lithium-ion secondary battery cathodes for high voltage operation, methods for the dry manufacture of such cathodes, and high voltage lithium-ion batteries implementing such cathodes.

### BACKGROUND

Various Li-ion battery (LIB) cathode materials have been successfully commercialized over the past two decades, including LiCoO₂ (LCO), LiNiₓMn_{y}Co_{z}O₂ (x+y+z=1) (NMC), LiNi_{0.8}Co_{0.15}Al_{0.05}O₂(NCA), LiFePO₄ (LFP), and LiMn₂O₄ (LMO). With increasing demand for electric vehicles (EVs) and electronic devices, both higher energy density and lower manufacturing cost are commercially desirable features for the next generation of secondary lithium ion batteries. Due to its high operating voltage (˜4.7 V) and absence of cobalt, LiNi_{0.5}Mn_{1.5}O₄ (LNMO) is perceived as one of the most promising cathode candidates. LNMO's high average operating voltage can effectively reduce the number of cells for a battery pack system, thus providing higher volumetric energy density. Unlike conventional cobalt-containing cathode materials such as LCO, NMC and NCA, the removal of expensive and toxic cobalt makes LNMO one of the most cost-effective cathode materials for electrified applications.

Despite high energy density and low cost, LNMO faces various challenges to commercialization. For example, a well-known drawback of LNMO is the poor cycling stability in a battery system. Due to LNMO's high working potential (˜4.7 V), the cathode and electrolyte must be capable of operating in an extremely oxidative environment. Particularly when using commercial hydrocarbon carbonate-based electrolytes which have poor oxidation stability, severe electrolyte decomposition and large amounts of parasitic reaction products will cause fast decay or even safety issues to a battery system. Another challenge of LNMO is its intrinsically low electronic conductivity (˜10⁻⁶ S/cm) which is one to two magnitudes lower than commercialized NMC, NCA and LCO. As a result, more than 5 wt % of conductive carbon has been used in published results to maintain an efficient conductive network. This in turn, however, decreases the energy density of the battery system due to the increased content of inactive components. Further, additional conductive carbon can catalyze additional side reactions, which exacerbates capacity decay. One of the most important side reactions is the reaction between trace amount of water with salt decomposition product PF₅ to form the strong acid HF, which will significantly corrode electrodes and interphase.

Efforts have been devoted to address and alleviate potential issues to improve the performance of LNMO. Developing novel electrolytes with additives is the most common strategy to stabilize the interphase of both cathode and anode. Among improvements observed in full cells, most were limited to 200 cycles, apart from a few that demonstrated longer cycle life using cathode loading less than 20 mg/cm², which makes the improvements less compatible with industry applications. Materials doping is another strategy to stabilize the cathode electrolyte interphase (CEI) while mitigating decomposition by HF. However, addition of expensive transition metals will unavoidably raise manufacturing costs. Surface coating applied on materials or electrode is another method explored to reduce cathode surface degradation and prolong cell cycling. Uniform coating and appropriate coating thickness can help to form a more robust CEI and prevent transition metal dissolution. However, scale up of sophisticated synthesis processes is a significant industrial challenge. Moreover, the cost of equipment and precursors in surface coating on electrode techniques such as atomic layer deposition (ALD) decreases their utility in large scale manufacturing.

Among the progress made to improve the performance of LNMO, few have considered the compatibility of the proposed strategies with thick electrodes, which is the most critical criteria towards practical usage. For LNMO, at least 3 mAh/cm² (˜21 mg/cm²) per side can be required to achieve around 300 Wh/kg. Previous works achieving this level of loading were limited by either low cycle number (less than 300 cycles) or poor capacity utilization. Therefore, to realize the potential of LNMO in industrially practical conditions, high loading must be achieved simultaneously with other modifications.

Effective fabrication of thick cathodes is an ongoing technical challenge in the Li-ion battery field. In slurry-based electrode fabrication, N-Methyl-2-pyrrolidone (NMP) is widely used as the solvent due to its excellent chemical and thermal stability as well as its ability to dissolve polyvinylidene fluoride (PVDF) binder, which offers high mechanical and electrochemical stability in cathode operation. The drying process of a thick cathode may lead to migration of binder and carbon to the top surface of electrode due to convective and capillary force developed in the process. As a result, poor adhesion between electrode and current collector will occur and can lead to severe electrode cracking. Tremendous efforts have thus been dedicated to exploring effective thick electrode fabrication processes, for example, using repeated coextrusion/assembly to create artificial channels to reduce tortuosity and improve the ionic flow, dispersing single-wall carbon nanotubes (SWCNT) to fabricate 800 μm thick electrodes, and utilizing novel binder such as polyacrylonitrile (PAN) to enable high loading. These methods, however, either have very complex fabrication procedures or are limited to lab scale processing. Another negative feature of NMP is its toxicity and requirement of expensive solvent recycling equipment, making the slurry-based fabrication process even more costly.

Unlike the above-mentioned methods, fabrication using binder fibrillation is a dry process, where fibrillizable polytetrafluoroethylene (PTFE) is a known utilized binder. In this process, PTFE particles are shear mixed and under these conditions become adhesive fibrils which can bind both conductive carbon and active materials, and such dry electrodes have been recently drawing increased industrial interest. Compared to the slurry-based method, this dry process has the potential to fabricate roll-to-roll electrode with unlimited thickness and minimal cracks. More importantly, the removal of toxic NMP and solvent recycling equipment makes the dry process a cost-effective and environmentally benign electrode manufacturing strategy.

### SUMMARY

The present invention addresses shortcomings of this prior work by offering a dry binder fibrillation process to fabricate cathodes for high voltage lithium-ion secondary batteries at various high loadings (>3 mAh/cm² level) and demonstrates the performance improvement of long-term cycling in the high voltage (>4.7 V) secondary lithium ion battery application. The stable cycling stability of a secondary lithium ion battery utilizing the cathode of the present invention can be ascribed in part to the combined factors of reduced parasitic reactions, robust mechanical properties, and a conducting structural web electronically connecting the cathode active particles so as to enable electronic conductivity through the electrode layer. In one embodiment, the present invention is a cathode for a high voltage lithium-ion secondary battery, comprising: an electrode layer comprising an electrode composition comprising cathode active particles, fluoropolymer binder and conductive carbon, wherein: the cathode active particles comprise lithium transition metal oxide having an electrochemical potential versus Li/Li+ of at least about 4.5 V; the fluoropolymer binder is a tetrafluoroethylene polymer having a melt creep viscosity of at least about 1.8×10¹¹ poise; the fluoropolymer binder is fibrillated; the conductive carbon comprises carbon fibers having a specific surface area of about 50 m²/g or less; the carbon fibers and the fibrillated fluoropolymer binder forming a conducting structural web electronically connecting the cathode active particles so as to enable electronic conductivity through the electrode layer, and wherein; the electrode layer is adhered to a current collector comprising aluminum having surface roughness and substantially no carbon surface coating other than the conductive carbon of the electrode layer.

In another embodiment, the present invention is a high voltage lithium-ion secondary battery comprising: a cathode comprising: an electrode layer comprising an electrode composition comprising cathode active particles, fluoropolymer binder and conductive carbon, wherein: the cathode active particles comprise lithium transition metal oxide having an electrochemical potential versus Li/Li+ of at least about 4.5 V; the fluoropolymer binder is a tetrafluoroethylene polymer having a melt creep viscosity of at least about 1.8×10¹¹ poise; the fluoropolymer binder is fibrillated; the conductive carbon comprises carbon fibers having a specific surface area of about 50 m²/g or less, the carbon fibers and the fibrillated fluoropolymer binder forming a conducting structural web electronically connecting the cathode active particles so as to enable electronic conductivity through the electrode layer, and wherein; the electrode layer is adhered to a current collector comprising aluminum having surface roughness and substantially no carbon surface coating other than the conductive carbon of said electrode layer;
an anode;
a separator between the cathode and the anode; and
an electrolyte in communication with the cathode, anode and separator.

In another embodiment, the present invention is a method for manufacturing a cathode for use in a high voltage lithium-ion secondary battery, comprising:
I.) dry milling a mixture of:
   i) conductive carbon, comprising carbon fibers, in a preferred embodiment the carbon fibers have a specific surface area of about 50 m²/g or less;
   ii) cathode active particles comprising lithium transition metal oxide having an electrochemical potential versus Li/Li+ of at least about 4.5 V; and
   iii) fluoropolymer binder comprising tetrafluoroethylene polymer having a melt creep viscosity of at least about 1.8×10¹¹ poise,
      to form a powdered dry cathode mixture, wherein the dry milling fibrillates the fluoropolymer binder and forms a conducting structural web comprising the fluoropolymer binder and the conductive carbon, the conducting structural web electronically connecting the cathode active particles so as to enable electronic conductivity throughout the cathode;
II.) calendaring the powdered dry cathode mixture to form a dry cathode electrode layer, and;
III.) adhering the dry cathode electrode layer to a current collector comprising aluminum having surface roughness and substantially no carbon surface coating other than the conductive carbon of the cathode electrode layer.

In another embodiment, the present invention is an electrically conducting structural web interconnecting electrically conductive particles, comprising:
carbon fibers and tetrafluoroethylene polymer having a melt creep viscosity of at least about 1.8×10¹¹ poise;
the carbon fibers and the tetrafluoroethylene polymer combined in the form of a conducting structural web electronically connecting the electrically conductive particles so as to enable structural reinforcement and electrical conductivity through a solid structure comprising the electrically conductive particles;
wherein a portion of the tetrafluoroethylene polymer and a portion of the carbon fibers in the web is a composite in the form of (A.) electrically conductive reinforcing strands comprising a continuous tetrafluoroethylene polymer matrix and a plurality of carbon fibers,
wherein the carbon fibers are embedded in and adhered to the tetrafluoroethylene polymer matrix comprising the strands, and
wherein the longitudinal axis of the carbon fibers is substantially aligned with the longitudinal axis of the strands, and
wherein the strands are randomly interwoven and interconnected throughout the volume in between the electrically conductive particles comprising the solid structure, and the strands are in contact with the electrically conductive particles.

### BRIEF DESCRIPTION OF THE DRAWINGS

FIG. 1. is a plan view image of the surface of a present electrode layer by SEM at 6.71 K magnification.

FIG. 2. is a plan view image of the surface of a present electrode layer by SEM at 14.04 K magnification.

FIG. 3. is a plan view image of the surface of a present electrode layer by SEM at 22.19 K magnification.

FIG. 4 is a plot of the C/10 rate half-cell performance (voltage (V)) vs specific capacity (mAh/g)) of half cell batteries using inventive dry method LNMO cathodes having areal loadings of 3, 4, 6 and 9.5 mAh/cm².

FIG. 5 is a plot of the C/10 rate half-cell performance (voltage (V)) vs specific capacity (mAh/g)) of half cell batteries using comparative slurry method LNMO cathodes having areal loadings of 3 and 4 mAh/cm².

FIG. 6 is a cross sectional SEM image of an LNMO cathode made by the inventive dry method of present Example 1 having areal capacity of 9.5 mAh/cm² corresponding to thickness of ˜240 μm.

FIG. 7 is a is a cross sectional SEM image of an LNMO cathode made by the comparative solvent slurry method of present Comparative Example 1 having areal capacity of 4 mAh/cm² corresponding to thickness of ˜110 μm.

FIG. 8 is a plot of long-term cycling (up to 1,000 cycles) of performance (specific capacity (mAh/g) and coulombic efficiency (%) vs cycle number) at C/3 rate of a full cell battery using the present inventive dry method prepared LMNO cathode, compared to a similar comparative full cell battery using a slurry method prepared LMNO cathode, each cathode having areal loading of 3 mAh/cm².

FIG. 9 is a plot of the average charge voltage (V) and average discharge voltage (V) vs cycle number over 300 cycles for a full cell battery using the present inventive dry method LMNO cathode, compared to a similar full cell battery using a slurry method prepared LNMO cathode, each cathode having areal loading of 3 mAh/cm².

FIG. 10 is a dQ/dV plot (dQ/dV (mAh/g·v⁻¹) vs voltage (V)) plot for a present inventive full cell battery using a present inventive dry method prepared LMNO cathode having areal loading of 3 mAh/cm².

FIG. 11 is a dQ/dV plot (dQ/dV (mAh/g·v⁻¹) vs voltage (V)) plot for a comparative full cell battery using a comparative slurry method prepared LNMO cathode having areal loading of 3 mAh/cm².

FIG. 12 is a Nyquist plot (−Z″/Ωvs Z′/Ω)) generated by Electrical Impedance Spectroscopy (EIS) for a present inventive full cell battery using the present inventive dry method prepared LMNO cathode, and a comparative full cell battery using a comparative slurry method prepared cathode, after 50 and 100 cycles, each cathode having areal loading of 3 mAh/cm².

FIG. 13 is a plot of the energy density (Wh/kg) and energy efficiency (%) vs cycle number over 300 cycles for a full cell battery using the present inventive dry method LMNO cathode, and a similar comparative full cell battery using a comparative slurry method prepared cathode.

FIG. 14 is a plot comparing performance (specific capacity (mAh/g) and coulombic efficiency (%) vs cycle number) of a full cell battery using an inventive dry method prepared LMNO cathode using Gen 2 electrolyte, and a similar inventive dry method prepared LMNO cathode using fluorinated (FEC-FEMC) electrolyte.

FIG. 15 is a plot of the energy density (Wh/kg) and energy efficiency (%) vs cycle number over 200 cycles for a full cell battery using an inventive dry method prepared LMNO cathode using Gen 2 electrolyte, and similar inventive dry method prepared LMNO cathode using fluorinated (FEC-FEMC) electrolyte, each cathode having areal loading of 3 mAh/cm².

FIG. 16 is a plot of average charge voltage (V) and average discharge voltage (V) vs cycle number over 200 cycles for a full cell battery using an inventive dry method prepared LMNO cathode using Gen 2 electrolyte, and similar inventive dry method prepared LMNO cathode using fluorinated (FEC-FEMC) electrolyte, each cathode having areal loading of 3 mAh/cm².

FIG. 17 is a plot of discharge capacity (mAh/g) and coulombic efficiency (%) vs cycle number for a full cell battery using an inventive dry method prepared LMNO cathode on a current collector comprising aluminum having substantially no carbon coating on the aluminum surface in contact with the electrode layer (other than the conductive carbon contained in the electrode layer), and a similar dry method prepared LMNO cathode on a current collector comprising aluminum having carbon coating, each cathode having an areal loading of 3 mAh/cm².

### DETAILED DESCRIPTION

### Cathode

The present electrode layer comprises an electrode composition in part comprising relatively high voltage operation capable cathode active particles comprising lithium transition metal oxide. The present cathode active particles have an electrochemical potential versus Li/Li+ of at least about 4.5 V, and in some embodiments have an electrochemical potential versus Li/Li+ of at least about 4.6 V. Example high voltage capable cathode active particles comprising lithium transition metal oxide are known in this field, and include lithium nickel manganese oxide, also referred to in this field as LNMO (e.g., LiNiₓMn₂₋ₓ O₄), and lithium-rich layered oxide, also referred to in this field as LRLO (e.g., Li_{1.098}Mn_{0.533}Ni_{0.113}Co_{0.138}O₂). Further examples include LiNi_{0.5}Mn_{1.5}O₄, LiNi_{0.45}Mn_{1.45}Cr_{0.1}O₄, LiCr_{0.5}Mn_{1.5}O₄, LiCrMnO₄, LiCu_{0.5}Mn_{1.5}O₄, LiCoMnO₄, LiFeMnO₄, LiNiVO₄, LiNiPO₄, LiCoPO₄ and Li₂CoPO₄F.

The present electrode layer comprises an electrode composition in part comprising conductive carbon comprising carbon fibers. The present carbon fibers have a length of from about 10 micrometers to about 200 micrometers. In some embodiments the present carbon fibers have a diameter of from about 0.1 micrometers to about 0.2 micrometers. The present carbon fibers have a specific surface area of about 50 m²/g or less. In some embodiments, the present carbon fibers have a specific surface area of about 40 m²/g or less, or about 30 m²/g or less, or about 20 m²/g or less. In some embodiments, the electrode layer is substantially free from conductive carbon having a specific surface area greater than about 50 m²/g, or greater than about 40 m²/g, or greater than about 30 m²/g, or greater than about 20 m²/g. Examples of such relatively low specific surface area conductive carbon comprising carbon fibers includes materials known as vapor grown carbon fiber, also referred to in this field as VGCF.

The present inventors discovered that conductive carbon having a relatively high surface area versus the present conductive carbon, results in poor battery cycling performance and coulombic efficiency when the present inventive batteries are operated at high voltage, due to decomposition of conventional electrolyte that is believed to occur catalyzed by such high surface area carbon during high voltage operation.

The present electrode layer comprises an electrode composition in part comprising fluoropolymer binder. The present fluoropolymer binder is a tetrafluoroethylene polymer having a melt creep viscosity of at least about 1.8×10¹¹ poise. In another embodiment, tetrafluoroethylene polymer has a melt creep viscosity of at least about 2.0×10¹¹ poise. In another embodiment, tetrafluoroethylene polymer has a melt creep viscosity of at least about 3.0×10¹¹ poise. In a preferred embodiment, tetrafluoroethylene polymer has a melt creep viscosity of at least about 4.0×10¹¹ poise. Herein, melt creep viscosity (MCV) is measured by the method described in Ebnesajjad, Sina, (2015), Fluoroplastics, Volume 1—Non-Melt Processible Fluoropolymers—The Definitive User's Guide and Data Book (2nd Edition), Appendix 5, Melt Creep Viscosity of Polytetrafluoroethylene, pp. 660-661, with reference to U.S. Pat. No. 3,819,594.

The present tetrafluoroethylene polymer is a polymer comprising repeating units of tetrafluoroethylene monomer, also referred to in this field as TFE, and has a melt creep viscosity of at least about 1.8×10¹¹ poise. With such high melt viscosity, the polymer does not flow in the molten state and therefore is not melt-processible. In one embodiment, the tetrafluoroethylene polymer is a tetrafluoroethylene homopolymer, consisting of repeating units of the tetrafluoroethylene monomer, also known in this field as polytetrafluoroethylene, abbreviated as PTFE. In another embodiment the tetrafluoroethylene polymer is a “modified” PTFE, modified PTFE referring to copolymers of TFE with such a small concentration of comonomer that the melting point of the resultant polymer is not substantially reduced below that of homopolymer PTFE. The concentration of such comonomer in a modified PTFE is less than 1 wt %, preferably less than 0.5 wt %. A minimum amount of at least about 0.05 wt % is generally used to have significant effect. Example comonomer in modified PTFE include perfluoroolefins, notably hexafluoropropylene (HFP) or perfluoro(alkyl vinyl ether) (PAVE), where the alkyl group contains 1 to 5 carbon atoms, with perfluoro(ethyl vinyl ether) (PEVE) and perfluoro(propyl vinyl ether) (PPVE) being preferred, chlorotrifluoroethylene (CTFE), perfluorobutyl ethylene (PFBE), or other similar monomers that introduce relatively bulky side groups into the polymer chain.

The present tetrafluoroethylene polymer is fibrillatable. By fibrillatable is meant that the tetrafluoroethylene polymer is capable of forming nanosized in at least one dimension (i.e. <100 nm width) fibrils which can vary in length from submicrometer, to several, to tens of micrometers in length when the tetrafluoroethylene polymer is subjected to shear forces, e.g., during practice of the present method.

The present electrode layer comprises an electrode composition comprising cathode active particles, fluoropolymer binder and conductive carbon, and in one embodiment contains from about 1 to about 10 weight percent conductive carbon, about 0.5 to about 5 weight percent fluoropolymer binder, and the remainder cathode active particles, based on the combined weight of said fluoropolymer binder, said cathode active particles, and said conductive carbon. In another embodiment, the electrode composition contains about 2 to about 7 weight percent conductive carbon, about 1 to about 3 weight percent fluoropolymer binder, and the remainder cathode active particles. In a preferred embodiment, the electrode composition contains about 5 weight percent conductive carbon, about 2 weight percent fluoropolymer binder.

The present electrode layer is adhered to a current collector comprising aluminum having surface roughness. In one embodiment, the surface roughness of the aluminum current collector expressed as Sa (arithmetical mean height) is at least about 260 nm. In another embodiment, the surface roughness of the aluminum current collector is at least about 280 nm. In a preferred embodiment, the surface roughness of the aluminum current collector is at least about 300 nm.

The present cathode has a loading level of cathode active particles on the current collector that is from at least about 10 to about 90 mg/cm².

The present electrode layer is adhered to a current collector comprising aluminum having substantially no carbon coating on the aluminum surface in contact with the electrode layer, other than the conductive carbon contained in the electrode layer. Conventional aluminum foil current collectors have a carbonaceous coating for the purpose of protecting the aluminum current collector. The present aluminum current collector is substantially free from such carbonaceous coatings. The present inventors discovered that the presence of carbon coating on the aluminum surface in contact with the electrode layer results in poor battery cycling performance and coulombic efficiency in the present inventive high voltage capable batteries. Without wishing to be bound to theory, the present inventors believe that this is due to decomposition of conventional electrolyte that is believed to occur catalyzed by such high surface area carbon coating during high voltage operation.

The present electrode layer may have a selected thickness suitable for certain battery applications. The thickness of an electrode layer as provided herein may be greater than that of an electrode layer prepared by conventional processes. This increase in thickness of the present electrode layer is enabled by the present carbon fibers and fibrillated fluoropolymer binder in the electrode layer forming a conducting structural web electronically connecting the cathode active particles so as to enable electronic conductivity through the relatively thicker electrode layer. In some embodiments, the electrode layer can have a thickness of at least about 60 micrometers, about 70 micrometers, about 80 micrometers, about 90 micrometers, about 100 micrometers, about 110 micrometers, about 115 micrometers, about 120 micrometers, about 130 micrometers, about 135 micrometers, about 140 micrometers, about 145 micrometers, about 150 micrometers, about 155 micrometers, about 160 micrometers, about 170 micrometers, about 180 micrometers, about 190 micrometers, about 200 micrometers, about 250 micrometers, about 260 micrometers, about 265 micrometers, about 270 micrometers, about 280 micrometers, about 290 micrometers, about 300 micrometers, about 350 micrometers, about 400 micrometers, about 450 micrometers, about 500 micrometers, about 750 micrometers, about 1 mm, or about 2 mm, or any range of values between. The present electrode layer thickness can be selected to correspond to a desired areal capacity, specific capacity, areal energy density, energy density, or specific energy density of the present inventive high voltage lithium-ion secondary battery.

In the present cathode for a high voltage lithium-ion secondary battery, the carbon fibers and the fibrillated fluoropolymer binder form a conducting structural web, that electronically connects the cathode active particles enabling electronic conductivity through the electrode layer, and that also maintains structural integrity in the electrode layer by securing the cathode active particles in place.

In one embodiment, the present invention is a cathode for a lithium-ion secondary battery, comprising: a cathode active layer comprising a conducting structural web connecting the substantially spherical cathode active particles in a cathode active layer of a lithium-ion secondary battery cathode, wherein the conducting structural web comprises PTFE binder and conductive carbon fibers, and wherein:
A. a portion of the PTFE and a portion of the carbon fibers in the web is combined in the form of conductive strands comprising a continuous PTFE matrix and a plurality of carbon fibers, wherein the carbon fibers are embedded in and adhered to the PTFE matrix comprising the strands, and wherein the longitudinal axis of the carbon fibers is substantially aligned with the longitudinal axis of the strands, and wherein the strands are randomly interwoven and interconnected throughout the volume between the cathode active particles, and are in contact with the cathode active particles;
B. a portion of the PTFE and a portion of the carbon fibers in the web is combined in the form of discontinuous randomly matted regions located adjacent and attached to the cathode active particles, wherein the carbon fibers are embedded in and adhered to the PTFE comprising the regions;
C. a portion of the PTFE in the web is in the form of free PTFE fibrils (i.e., PTFE fibrils substantially free from carbon fibers);
D. a portion of the PTFE in the web is in the form of a PTFE coating layer covering a portion of the surface of some cathode active particles, and
E. a portion of the carbon fibers in the web are free conductive carbon fibers (i.e., carbon fibers substantially free from PTFE); and
   wherein the conductive strands (A.), the discontinuous random matted regions (B.), the free fluoropolymer fibrils (C.), the PTFE coating layers (D.), and the free conductive carbon fibers (E.) are randomly interconnected with one another throughout the electrode layer, and are in contact with the surface of the cathode active particles, thereby forming the conducting structural web electrically connecting and securing in place the cathode particles.

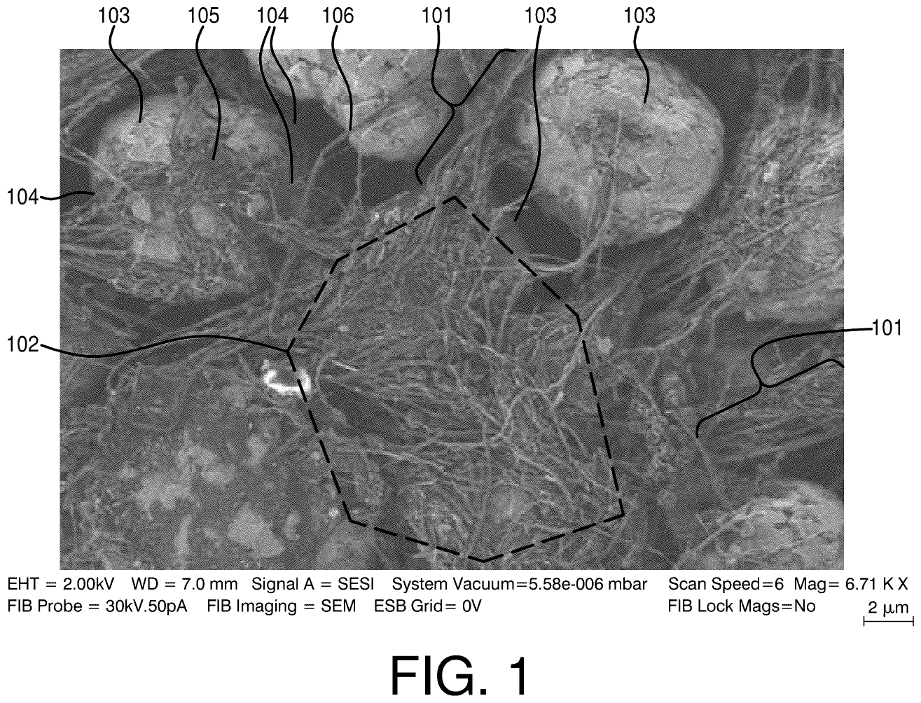

FIG. 1. is a plan view image of the surface of a present electrode layer by SEM at 6.71 K magnification. 101 are conductive strands comprising PTFE and carbon fibers (A.). 102 is a PTFE and carbon fiber discontinuous matted region located between and attached to cathode active particles 103 (B.). 104 is PTFE in the form of free fluoropolymer fibrils (C.). 105 is PTFE in the form of a coating layer covering a portion of a cathode particle 103 (D.). 106 is a free carbon fiber.

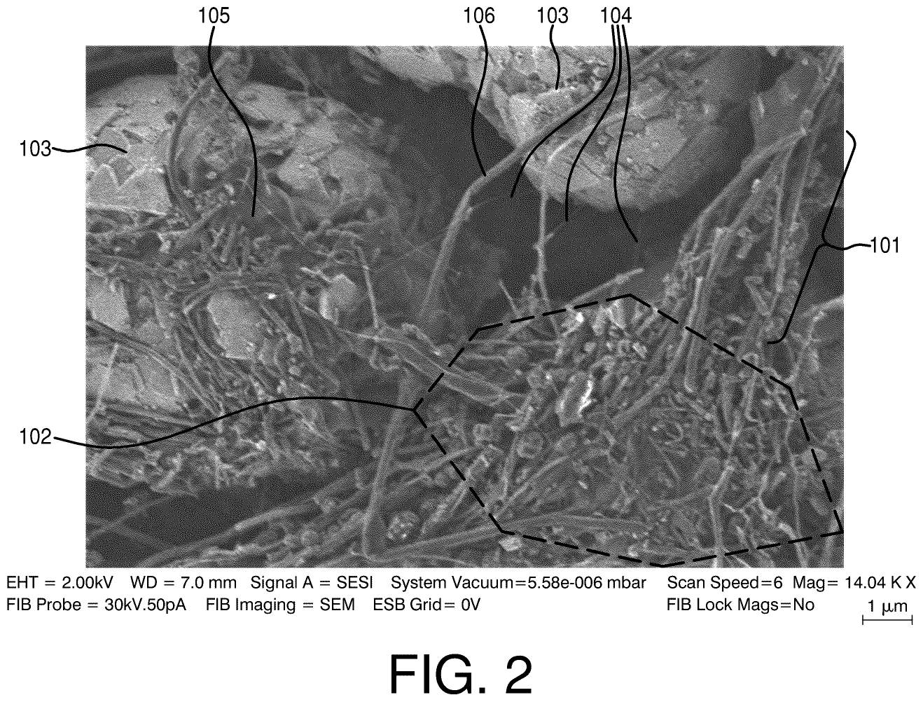

FIG. 2. is a plan view image of the surface of a present electrode layer by SEM at 14.04 K magnification, further magnifying a portion of the FIG. 1 image. 101 is a conductive strand comprising PTFE and carbon fibers (A.). 102 is a PTFE and carbon fiber discontinuous matted region located between and attached to cathode active particles 103 (B.). 104 is PTFE in the form of free fluoropolymer fibrils (C.). 105 is PTFE in the form of a coating layer covering a portion of a cathode particle 103 (D.). 106 is a free carbon fiber.

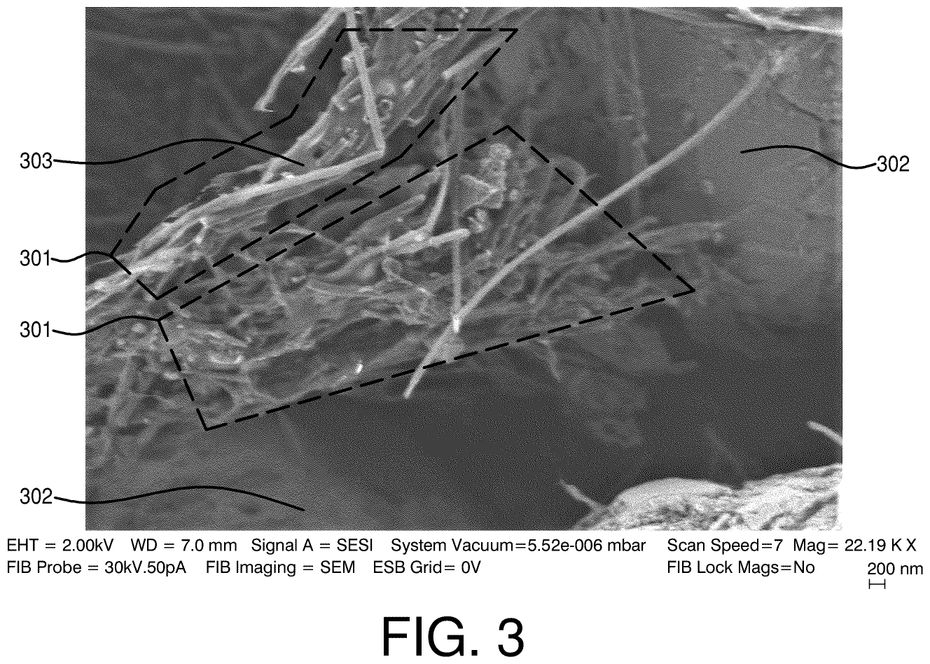

FIG. 3. is a plan view image of the surface of a present electrode layer by SEM at 22.19 K magnification. 301 are two conductive strands comprising PTFE and carbon fibers (A.) in the volume between, and in contact with, cathode active particles 302. The PTFE phase can be clearly seen at 303.

The present inventive conducting structural web comprising fibrillated PTFE binder and conductive carbon fibers enables formation of electrodes much thicker than conventional electrodes having excellent conductivity throughout the entire volume of such relatively thicker electrode. Conductivity can be assessed by conventional methods, for example the 2-point probe and 4-point probe conductivity methods. In some embodiments, the thickness of the present electrode layer is at least about X micrometers, and the 2-point probe conductivity is at least about 1×10⁻² S/cm, and the 4-point probe conductivity is at least about 1×10⁻² S/cm. Herein, X is selected from the group consisting of the following values: 60, 70, 80, 90, 100, 110, 115, 120, 130, 135, 140, 145, 150, 155, 160, 170, 180, 190, 200, 250, 260, 265, 270, 280, 290, 300, 350, 400, 450, 500, 750, 1,000 (i.e., 1 mm), and 2,000 (i.e., 2 mm), and any range of values between these values.

In one embodiment, the present invention can be descried as an electrically conducting structural web interconnecting electrically conductive particles, comprising:
carbon fibers and tetrafluoroethylene polymer having a melt creep viscosity of at least about 1.8×10¹¹ poise;
the carbon fibers and the tetrafluoroethylene polymer combined in the form of a conducting structural web electronically connecting the electrically conductive particles so as to enable structural reinforcement and electrical conductivity through a solid structure comprising the electrically conductive particles;
wherein a portion of the tetrafluoroethylene polymer and a portion of the carbon fibers in the web is a composite in the form of (A.) electrically conductive reinforcing strands comprising a continuous tetrafluoroethylene polymer matrix and a plurality of carbon fibers,
wherein the carbon fibers are embedded in and adhered to the tetrafluoroethylene polymer matrix comprising the strands, and
wherein the longitudinal axis of the carbon fibers is substantially aligned with the longitudinal axis of the strands, and
wherein the strands are randomly interwoven and interconnected throughout the volume in between the electrically conductive particles comprising the solid structure, and the strands are in contact with the electrically conductive particles.

In one embodiment, the electrically conducting structural web further comprises at least one of:
B. a portion of the tetrafluoroethylene polymer and a portion of the carbon fibers in the web is combined in the form of discontinuous randomly matted regions located adjacent to and attached to the electrically conductive particles, wherein the carbon fibers are embedded in and adhered to the tetrafluoroethylene polymer comprising the regions;
C. a portion of the tetrafluoroethylene polymer in the web is in the form of free tetrafluoroethylene polymer fibrils;
D. a portion of the tetrafluoroethylene polymer in the web is in the form of a tetrafluoroethylene polymer coating layer covering a portion of the surface of some of the electrically conductive particles; and
E. a portion of the carbon fibers in the web are free conductive carbon fibers;
and wherein the electrically conductive reinforcing strands (A.), the discontinuous random matted regions (B.), the free fluoropolymer fibrils (C.), the tetrafluoroethylene polymer coating layers (D.), and the free conductive carbon fibers (E.) are randomly interconnected with one another throughout the electrically conducting structural web, and are in contact with the surface of the electrically conductive particles, thereby forming the conducting structural web electrically connecting and securing in place the electrically conductive particles.

In a preferred embodiment, the electrically conducting structural web comprises all of the aforementioned elements A., B., C., D. and E.

In one embodiment of the electrically conducting structural web, the carbon fibers (conductive carbon) have a specific surface area of about 50 m²/g or less. In an alternate embodiment of the electrically conducting structural web, the carbon fibers have a specific surface area of about 40 m²/g or less. In an alternate embodiment of the electrically conducting structural web, the carbon fibers have a specific surface area of about 30 m²/g or less. In an alternate embodiment of the electrically conducting structural web the carbon fiber have a specific surface area of about 20 m²/g or less.

In one embodiment of the electrically conducting structural web, the carbon fibers have a length of from about 10 micrometers to about 200 micrometers. In one embodiment of the electrically conducting structural web the conductive carbon fibers have a diameter of from about 0.1 micrometers to about 0.2 micrometers.

In one embodiment of the electrically conducting structural web the tetrafluoroethylene polymer has a melt creep viscosity of at least about 2.0×10¹¹ poise. In an alternate embodiment of the electrically conducting structural web, the tetrafluoroethylene polymer has a melt creep viscosity of at least about 3.0×10¹¹ poise. In an alternate embodiment of the electrically conducting structural web, the tetrafluoroethylene polymer has a melt creep viscosity of at least about 4.0×10¹¹ poise.

In one embodiment, the electrically conducting structural web is formed by a process free from solvent. In an alternate embodiment, the electrically conducting structural web is formed by dry mixing the particles, tetrafluoroethylene polymer and carbon fibers to form an electrode composition, and applying a shear force to the electrode composition in the absence of solvent to form the electrically conducting structural web.

In one embodiment of the electrically conducting structural web, the conductive carbon fibers comprise vapor grown carbon fibers (VGCF).

In one embodiment of the electrically conducting structural web, the particles are active particles comprising lithium transition metal oxide having an electrochemical potential versus Li/Li+ of at least about 4.5 V. In an alternate embodiment of the electrically conducting structural web, the particles are active particles comprising lithium transition metal oxide having an electrochemical potential versus Li/Li+ of at least about 4.6 V. In one embodiment of the electrically conducting structural web, the lithium transition metal oxide is selected from the group consisting of LiNiₓMn₂₋ₓ O₄ (LNMO) and Li_{1.098}Mn_{0.533}Ni_{0.113}Co_{0.13802} (Li-rich layered oxide (LRLO)). In one embodiment of the electrically conducting structural web, the lithium transition metal oxide is selected from the group consisting of LiNi_{0.5}Mn_{1.5}O₄, LiNi_{0.45}Mn_{1.45}Cr_{0.1}O₄, LiCr_{0.5}Mn_{1.5}O₄, LiCrMnO₄, LiCu_{0.5}Mn_{1.5}O₄, LiCoMnO₄, LiFeMnO₄, LiNiVO₄, LiNiPO₄, LiCoPO₄ and Li₂CoPO₄F.

In one embodiment of the electrically conducting structural web, the tetrafluoroethylene polymer is fibrillated such that the electrically conducting structural web is self-supporting.

In one embodiment, the thickness of the electrically conducting structural web is from about 60 micrometers to about 250 micrometers. In an alternate embodiment, the thickness of the electrically conducting structural web is from about 80 micrometers to about 120 micrometers. In an alternate embodiment, the thickness of electrically conducting structural web is at least about 240 micrometers.

### Battery

In one embodiment the present invention is a high voltage lithium-ion secondary battery comprising: a cathode as defined earlier herein, an anode, a separator between the cathode and the anode, and an electrolyte in communication with the cathode, anode and separator.

Anodes of the present invention include anodes capable of continuous high voltage operation of the present battery, examples include: graphite anodes, pure silicon anodes, or lithium metal anodes.

In one embodiment the anode of the present battery is a graphite anode. In one embodiment the graphite anode comprises from about 80% to about 98% by weight active material with a specific capacity of at least about 300 to about 370 mAh/g at a discharge rate of at least about C/20 to about 2C, and has a loading level of anode active material that is at least about 5 to about mg/cm². Following activation of the battery in a first charge cycle the negative electrode has a specific discharge capacity of at least about 300 to about 370 mAh/g based on the weight of the negative electrode active material at a rate of at least about C/20 to about 2C and the battery has a discharge energy density of at least about 260 to about 340 Wh/kg at a rate of at least about C/20 to about 5 C, and the battery has a discharge energy density at the 100th charge-discharge cycle of at least about 90% of the discharge energy density at the third cycle.

In one embodiment the anode is a pure silicon anode and the battery has a discharge energy density of at least about 340 to about 650 Wh/kg at a rate of at least about C/20 to about 5 C, and the battery has a discharge energy density at the 100th charge-discharge cycle of at least about 90% of the discharge energy density at the third cycle.

In one embodiment the anode is a lithium metal anode and the battery has a discharge energy density of at least about 300 to about 560 Wh/kg at a rate of at least about C/20 to about 5 C, and the battery has a discharge energy density at the 100th charge-discharge cycle of at least about 90% of the discharge energy density at the third cycle.

Separators of the present high voltage lithium-ion secondary battery invention include conventional separators for lithium-ion secondary batteries capable of continuous high voltage operation of the present battery. The separator is configured to electrically insulate two electrodes adjacent to opposing sides of the separator, while permitting ionic communication between the two adjacent electrodes. The separator can comprise a suitable porous, electrically insulating material. In some embodiments, the separator can comprise a polymeric material. For example, the separator can comprise a cellulosic material (e.g., paper), a polyethylene resin, a polypropylene resin and/or mixtures thereof.

Electrolytes of the present high voltage lithium-ion secondary battery invention include conventional electrolytes for lithium-ion secondary batteries capable of continuous high voltage operation of the present battery. The present electrolyte facilitates ionic communication between the electrodes of present battery, and is typically in contact with the cathode, anode and the separator. In one embodiment, present battery uses a suitable lithium-containing electrolyte. For example, a lithium salt, and a solvent, such as a non-aqueous or organic solvent, or fluorinated organic solvent. Generally, the lithium salt includes an anion that is redox stable. In some embodiments, the anion can be monovalent. In some embodiments, a lithium salt can be selected from hexafluorophosphate (LiPF₆), lithium tetrafluoroborate (LiBF₄), lithium perchlorate (LiClO₄), lithium bis(trifluoromethansulfonyl)imide (LiN(SO₂CF₃)₂), lithium trifluoromethansulfonate (LiSO₃CF₃), lithium bis(oxalate)borate (LiBOB) and combinations thereof. In some embodiments, the electrolyte can include a quaternary ammonium cation and an anion selected from the group consisting of hexafluorophosphate, tetrafluoroborate and iodide. In some embodiments, the salt concentration can be about 0.1 mol/L (M) to about 5 M, about 0.2 M to about 3 M, or about 0.3 M to about 2 M. In further embodiments, the salt concentration of the electrolyte can be about 0.7 M to about 1 M. In certain embodiments, the salt concentration of the electrolyte can be about 0.2 M, about 0.3 M, about 0.4 M, about 0.5 M, about 0.6 M, about 0.7 M, about 0.8 M, about 0.9 M, about 1 M, about 1.1 M, about 1.2 M, or any range of values therebetween.

In some embodiments, electrolytes of the present high voltage lithium-ion secondary battery invention include a liquid solvent. In further embodiments, the solvent can be an organic solvent. In some embodiments, a solvent can include one or more functional groups selected from carbonates, ethers and/or esters. In some embodiments, the solvent can comprise a carbonate. In further embodiments, the carbonate can be selected from cyclic carbonates such as, for example, ethylene carbonate (EC), propylene carbonate (PC), vinyl ethylene carbonate (VEC), vinylene carbonate (VC), fluoroethylene carbonate (FEC), methyl(2,2,2-trifluoroethyl) carbonate (FEMC) and combinations thereof, or acyclic carbonates such as, for example, dimethyl carbonate (DMC), diethyl carbonate (DEC), ethyl methyl carbonate (EMC), and combinations thereof. In certain embodiments, the electrolyte can comprise LiPF6, and one or more carbonates. An example organic solvent electrolyte includes the electrolyte known in this field as “Gen 2” electrolyte, which is 1.0 M LiPF₆ in ethylene carbonate (EC) and ethylmethyl carbonate (EMC), EC:EMC ratio of 3:7 by weight. In a preferred embodiment, electrolyte for use in the present high voltage lithium-ion secondary battery invention is the fluorinated organic solvent electrolyte. For example, fluorinated electrolyte referred to as FEC-FEMC, which is 1 M LiPF₆ in fluoroethylene carbonate (FEC) and methyl(2,2,2-trifluoroethyl) carbonate (FEMC), having an FEC:FEMC ratio of 1:9 by volume.

In one embodiment, the present lithium-ion secondary battery is capable of energy density of at least about 350 Wh/kg at a rate of at least about C/20. In another embodiment, the present lithium-ion secondary battery is capable of energy density of at least about 400 Wh/kg at a rate of at least about C/20. In another embodiment, the present lithium-ion secondary battery is capable of energy density of at least about 450 Wh/kg at a rate of at least about C/20. In another embodiment, the present lithium-ion secondary battery is capable of energy density of at least about 500 Wh/kg at a rate of at least about C/20. In another embodiment, the present lithium-ion secondary battery is capable of energy density of at least about 550 Wh/kg at a rate of at least about C/20. In another embodiment, the present lithium-ion secondary battery is capable of energy density of at least about 600 Wh/kg at a rate of at least about C/20. In another embodiment, the present lithium-ion secondary battery is capable of energy density of at least about 650 Wh/kg at a rate of at least about C/20.

### Method

In one embodiment the present invention is a method for manufacturing a cathode as defined earlier herein for use in a high voltage lithium-ion secondary battery, the method comprising:
I.) dry milling a mixture of:
   i) conductive carbon, comprising carbon fibers having a length of from about 10 micrometers to about 200 micrometers and a specific surface area of about 50 m²/g or less,
   ii) cathode active particles comprising lithium transition metal oxide having an electrochemical potential versus Li/Li+ of at least about 4.5 V; and
   iii) fluoropolymer binder comprising tetrafluoroethylene polymer having a melt creep viscosity of at least about 1.8×10¹¹ poise, to form a powdered dry cathode mixture, wherein the dry milling fibrillates the fluoropolymer binder and forms a conducting structural web comprising the fluoropolymer binder and the conductive carbon, the conducting structural web electronically connecting the cathode active particles so as to enable electronic conductivity throughout the cathode;
II.) calendaring the powdered dry cathode mixture to form a dry cathode electrode layer, and;
III.) adhering the dry cathode electrode layer to a current collector comprising aluminum having surface roughness and substantially no carbon surface coating other than the conductive carbon of the cathode electrode layer.

The present dry milling step substantially homogeneously distributes the relatively smaller mass of carbon fibers and fluoropolymer binder with the relatively larger mass of cathode active particles.

In one embodiment, the carbon fibers subjected to the I.) dry milling step are in the form of agglomerates, and the dry milling is sufficient to substantially deagglomerate such agglomerates, resulting in singular carbon fibers and/or relatively small clusters of carbon fibers.

In the present method, the electrode layer is formed by a method free from the use of solvent. In one embodiment of the present method, the electrode layer is formed by dry mixing the cathode active particles, fluoropolymer binder and conductive carbon in the absence of organic solvent or water to form a dry electrode composition, and applying a shear force to the dry electrode composition in the absence of solvent to form the electrode layer.

In one embodiment, the fluoropolymer binder is fibrillated such that the cathode electrode layer is self-supporting. By self-supporting is meant that the cathode electrode layer has sufficient tensile strength and tear and fracture resistance such that the cathode electrode layer can be manufactured and handled as a self-supporting film without a backing or supporting film, and manipulated and applied to a current collector without suffering failure (e.g., crack, tear, wrinkling, buckling, stretching, etc.)

In one embodiment of the present method, the I.) dry milling step further comprises: dry milling under first conditions a mixture comprising the conductive carbon and the dry cathode active particles, resulting a first dry mixture, and then adding the dry fluoropolymer binder to the first dry mixture to form a second dry mixture, and dry milling under second conditions the second dry mixture to form the powdered dry cathode mixture wherein the fluoropolymer binder is fibrillated.

The present dry milling step I.) is carried out at elevated temperature from room temperature. In one embodiment, dry milling is carried out at a temperature of from about 40° C. to about 150° C.

The present dry milling step I.) is carried out by application of shear to the materials being milled. In the embodiment wherein the conductive carbon, cathode active particles and fluoropolymer binder are combined and then milled together all at once, the shear applied will be sufficient to homogeneously distribute the materials and fibrillate the fluoropolymer binder, without substantially fracturing the conductive carbon fibers or the cathode active particles.

In one embodiment where the conductive carbon fibers are initially obtained from a supplier as agglomerates, it is preferrable to dry mill sufficient to substantially deagglomerate the agglomerates of conductive carbon, resulting in singular carbon fibers and/or relatively smaller clusters of carbon fibers. In this embodiment, the conductive carbon fibers can dry milled alone, or in a preferred embodiment, together with the cathode active particles, resulting in the conductive carbon being singular carbon fibers or relatively smaller clusters of carbon fibers, the conductive carbon being homogenously dispersed throughout the cathode active particles. In this embodiment, fluoropolymer binder can then subsequently be added to the milled mixture of conductive carbon and cathode active particles, and then this mixture further milled, to homogeneously distribute all materials and fibrillate the fluoropolymer binder, without substantially fracturing the conductive carbon fibers or the cathode active particles.

In one embodiment, the dry milling is carried out by rolling, such as in a bottle roller, or for example in a rotary drum mixer, such that sufficient shear force is imparted so that the fluoropolymer binder is fibrillated and the carbon fibers are substantially unbroken and are homogeneously distributed throughout the powdered dry cathode active particles, and also resulting in formation of the conducting structural web comprising the fluoropolymer binder and the conductive carbon. In one embodiment, rolling can be carried out at a revolution rate of from about 30 to about 150 rpm. In a preferred embodiment, rolling is carried out at a revolution rate of from about 70 to about 90 rpm. In a preferred embodiment, rolling is carried out at a revolution rate of from about 80 rpm. In one embodiment, rolling can be carried out for a duration of from about at least about 1 hour. In one embodiment rolling is carried out at elevated temperature from room temperature. In one embodiment rolling is carried out at a temperature of from about 70° C. to about 250° C. In a preferred embodiment rolling is carried out at a temperature of about 80° C.

In one embodiment, the dry milling is carried out using a mortar and pestle at an elevated temperature (e.g., 80° C.) for a period and applied shear force sufficient to result in homogeneous mixing of the materials, fibrillation of the PTFE and formation of the conductive structural web. In the mortar and pestle milling method, care needs to be taken to not impart excess shear on the mixture, so as to undesirably substantially fragment (shorten) the fibers of the VGCF and/or substantially fragment the LNMO. In one embodiment, the dry milling is carried out using a mortar and pestle at an elevated temperature of from about 30° C. to about 150° C. In one embodiment, the dry milling is carried out using a mortar and pestle for a time period of from about 10 minutes to about 1 hour.

The present method involves the step II.) of calendaring the powdered dry cathode mixture to form a dry cathode electrode layer. In one embodiment, the present calendaring step II.) is carried out at elevated temperature from room temperature. In one embodiment calendaring is carried out at a temperature of from about 70° C. to about 250° C. In one embodiment the present calendaring step II.) is carried out under applied pressure. In one embodiment, the applied pressure is from about 1 metric ton to about 10 metric tons.

The present method involves the step of III.) applying the dry cathode electrode layer to a current collector comprising aluminum having surface roughness and substantially no carbon surface coating other than said conductive carbon of said electrode layer. In one embodiment, the present applying step III.) is carried out at elevated temperature from room temperature. In one embodiment such applying is carried out at a temperature of from about 70° C. to about 250° C. In one embodiment the present applying step III.) is carried out under applied pressure. In one embodiment, the applied pressure is from about 1 metric ton to about 10 metric tons.

The present III.) applying step can be carried out by preparing a cathode electrode layer and applying the cathode electrode layer to a current collector at an elevated temperature and under applied pressure. In an alternate embodiment, the present III.) applying step can be carried out simultaneously with the II.) calendaring step, wherein the cathode electrode layer is formed and applied to the current collector in a single calendaring step.

### EXAMPLES

### Example 1—Dry Method for Preparation of Inventive Cathodes

The materials used to prepare cathodes of the present invention were commercially available battery grade materials: lithium nickel manganese oxide (LNMO) cathode active from Haldor Topsoe, vapor grown carbon fiber (VGCF) conductive carbon from Sigma Aldrich having surface area less than 50 m²/g and polytetrafluoroethylene (PTFE) fluoropolymer binder having a melt creep viscosity of at least about 1.8×10¹¹ poise manufactured by Chemours FC LLC. All materials were used dry (i.e., not containing, dissolved in, or carried/dispersed in water or an organic solvent) and as otherwise obtained from the manufacturer. The cathode active materials were stored and manipulated in an oxygen-free drybox under an Ar atmosphere. The PTFE fluoropolymer binder is stored at 0° C. prior to use.

The materials were combined in the desired weight ratio in an appropriately sized rolling container (bottle) and rolled using a bottle roller at 80 rpm and a temperature of 80° C. for a period of 24 hours to sufficiently mix the materials, fibrillate the PTFE and form the conductive structural web.

In an alternate and preferred embodiment, the cathode active (LNMO) and conductive carbon (VGCF) were combined and milled first in the absence of the fluoropolymer binder (PTFE), for a period sufficient to substantially break up VGCF agglomerates, separate the fibers of VGCF and homogeneously mix the VGCF and LNMO. Subsequently, the PTFE was added, and the mixture was further rolled using the bottle roller to homogeneously mix the PTFE with the previously milled VGCF and LNMO, fibrillate the PTFE, and form a milled dry cathode powder comprising the present conductive structural web.

The obtained milled dry cathode powder LNMO, VGCF and PTFE mixture was then calendared to form a dry cathode electrode layer of desired thickness. Calendaring was carried out in a MTI rolling press under the conditions of temperature of 70 to 200° C. and pressure of 1 to 10 metric tons for a time of 5 to 40 seconds to result in a dry cathode active layer of the desired thickness. The present inventive dry cathode active layer is self-supporting, meaning that it has sufficient strength (e.g., tensile, tear and fracture resistance) such that it could be handled and manipulated as a self-supporting film, without requiring a backing or supporting film, and manipulated (e.g., rolled, slit, etc.) and applied to a current collector without suffering failure (e.g., crack, tear, fracture, wrinkling, buckling, stretching, etc.).

The obtained cathode active layer was then adhered to an aluminum current collector having surface roughness of expressed as Sa (arithmetical mean height) of at least about 260 nm and having no carbon surface coating. Adhering of the cathode active layer and aluminum current collector was carried out at elevated temperature from room temperature, at a temperature of from about 70° C. to about 250° C., and under applied pressure, at an applied pressure of from about 1 metric ton to about 10 metric tons resulting for formation of an inventive cathode.

### Comparative Example 1—Solvent Slurry Method Preparation of Comparative Cathode

The materials used to prepare cathodes using the comparative solvent slurry method were commercially available battery grade materials: lithium nickel manganese oxide (LNMO) cathode active from Haldor Topsoe, Super C65 (C65) conductive carbon from MTI Corporation and HSV-900 polyvinylidene fluoride (PVDF) from Arkema. After weighing materials with designed weight ratio, PVDF was transferred into N-Methyl-2-pyrrolidone (NMP, from Sigma Aldrich) solvent in a jar. A Thinky mixer (ARE-310) was used to mix and dissolve the PVDF. LNMO and SC65 were then added into the mixture and continued mixing for another 1 hour without any milling beads. The slurry was then casted onto a current collector with film casting doctor blade (Futt Brand). The casted slurry was dried in a vacuum oven (MTI Corporation) under 80° C. for 24 hours. A rolling press machine (MTI Corporation) was used to calendar the dried electrodes to reduce the porosity to about 35%.

### Example 2—Electronic Conductivity of Inventive Cathodes of Different Areal Capacity

Cathodes of varying cathode layer areal capacity and thickness were prepared using the dry method and materials described in Example 1. The weight ratio of LNMO:PTFE:VGCF in the cathode electrode layer is 93:2:5. Conductivity of the cathodes was measured by the 2-point probe conductivity and 4-point conductivity methods, and the results are reported in Table 1.

The 2 and 4-point conductivity test methods are generally known to those of ordinary skill in this field, as typical methods to evaluate electronic conductivity of electrodes in the battery field, and are also disclosed in references, e.g., : i) Park, Sang-Hoon, et al. “High areal capacity battery electrodes enabled by segregated nanotube networks.” Nature Energy 4.7 (2019): 560-567; ii) Liu, G., et al. “Effects of various conductive additive and polymeric binder contents on the performance of a lithium-ion composite cathode.” Journal of The Electrochemical Society 155.12 (2008): A887; and iii) Entwistle, Jake, et al. “Carbon binder domain networks and electrical conductivity in lithium-ion battery electrodes: A critical review. “Renewable and Sustainable Energy Reviews 166 (2022): 112624”.

TABLE 1

| Cathode Areal | Cathode Layer | 4-point probe | 2-point probe |
|---|---|---|---|
| Capacity | Thickness | conductivity | conductivity |
| (mAh/cm²) | (μm) | (S/cm) | (S/cm) |
| 3 | 86 | 4.06 × 10⁻² | 5.66 × 10⁻³ |
| 4 | 107 | 6.50 × 10⁻² | 7.58 × 10⁻³ |
| 6 | 160 | 5.35 × 10⁻² | 1.14 × 10⁻² |
| 9.5 | 240 | 7.50 × 10⁻² | 1.71 × 10⁻² |

The inventive cathodes having different areal loadings show the same order of magnitude of electronic conductivity by the 4-point probe conductivity method. Without wishing to be bound to theory, the present inventors believe that this relates to the in-plane conductive carbon tortuosity. Electronic conductivity by the 2-point probe method exhibits an increasing trend as areal loading is increased. Without wishing to be bound to theory, the present inventors believe that this is due to reduction of the thickness in the cathode layer during the calendaring step, which will disperse the carbon fibers and result in less carbon fibers per unit volume in a resultant thinner cathode (i.e., a larger area cathode layer film is obtained by calendaring the cathode composition to reduce cathode layer film thickness).

### Example 3—Electronic Conductivity of Inventive Cathodes with Varying Content of Conductive Carbon (VGCF)

Cathodes of similar areal capacity (3 mAh/cm²) and thickness were prepared by the present dry method and materials described in Example 1. The weight ratio of LNMO:PTFE:VGCF in the electrode layer was varied as shown in Table 2. Conductivity of the cathodes was measured by the 4-point conductivity method, and the results are reported in Table 2.

TABLE 2

| | Cathode Layer | 4-point probe |
|---|---|---|
| LNMO:PTFE:VGCF | Thickness | conductivity |
| weight ratio | (μm) | (S/cm) |
| 93:2:5 | 86 | 4.06 × 10⁻² |
| 96:1:3 | 84 | 4.00 × 10⁻² |
| 97:1:2 | 81 | 1.66 × 10⁻⁴ |
| 98:1:1 | 76 | 5.31 × 10⁻⁷ |

These results show that reducing the amount of VGCF, especially below 3 wt %, has a relatively large impact on the conductivity as measured by 4-point probe conductivity. Without wishing to be bound by theory, the present inventors believe that the present inventive electrodes containing less than 3 wt % VGCF are less able to connect the cathode active particles and less able to form an effective electronic conducting structural web. Below this amount, it appears that the measured conductivity essentially corresponds to that of the LNMO cathode active particles, which is on the order of ˜1×10⁻⁶ S/cm.

### Example 4—Electronic Conductivity of Inventive Cathodes Made by Different Cathode Electrode Composition Milling Methods

Three different milling methods were studied to prepare electrode compositions comprising cathode active particles, fluoropolymer binder and conductive carbon: Thinky mixer method, bottle roller method, and mortar and pestle method.

The Thinky mixer method involved use of a Thinky planetary centrifugal mixer model ARE-310 to mix a LNMO:PTFE:VGCF composition as described in Table 3. The mixer was operated under the following conditions: 2,000 rpm for 30 minutes. Prepared was a dry powdered LNMO:PTFE:VGCF cathode electrode mixture.

The bottle roller mixing method generally followed that as described in Example 1. An about 2 g amount of a LNMO:PTFE:VGCF mixture was placed into a 20 ml glass vial and rolled on a bottle mixer at 80 rpm and 80° C. for 24 hours, without milling beads in one trial, and with 4 milling beads in another trial, to prepare a dry powdered LNMO:PTFE:VGCF cathode mixture. Use of milling beads in the bottle roller mixing method was found to be undesirable, as the presence of milling beads undesirably led to substantially fragmented (shortened) fibers of VGCF and/or substantially fragmented LNMO particles. Bottle roller mixing at relatively lower mixing speeds (below 80 rpm) was found to not adequately disperse the VGCF, rather, result in agglomeration of the VGCF.

The mortar and pestle mixing method generally followed that of present Example 1. An amount of the LNMO:PTFE:VGCF mixture was placed into a mortar and pestle and gently mixed by hand while heating to 80° C. until the powder mixture was visibly uniform, to prepare a dry powdered LNMO:PTFE:VGCF cathode electrode mixture.

Cathodes of similar areal capacity were prepared by the present dry method using the dry powdered LNMO:PTFE:VGCF cathode electrode mixtures prepared by the above described mixing methods, and the materials as described in present Example 1. The weight ratio of LNMO:PTFE:VGCF in the electrode layer is reported in Table 3. Conductivity of the cathodes was measured by the 4-point conductivity method, and the results are reported in Table 3.

TABLE 3

| Cathode Electrode | | | |
|---|---|---|---|
| Composition | Electrode | | |
| Manufacturing Method, | Areal | Electrode | 4-point probe |
| LNMO:PTFE:VGCF | Capacity | thickness | conductivity |
| Weight Ratio | (mAh/cm²) | (μm) | (S/cm) |
| Thinky mixer, | 3 | 86 | 4.06 × 10⁻² |
| 93:2:5 | | | |
| Thinky mixer, | 3 | 81 | 1.66 × 10⁻⁴ |
| 97:1:2 | | | |
| Thinky mixer, | 4 | 130 | 1.05 × 10⁻⁴ |
| 97:1:2 | | | |
| Bottle roller mixing, | 4 | 130 | 4.06 × 10⁻² |
| 97:1:2 | | | |
| Mortar and pestle | 4 | 130 | 1.63 10⁻¹ |
| mixing, | | | |
| 97:1:2 | | | |

### Example 5—Electrochemical Performance of Half Cell and Full Cell Batteries Using LNMO Cathodes Made by Inventive Dry Coating Method, and Cathodes Made by Comparative Solvent Slurry Method

Cathodes were prepared according to the bottle roller mixing method of Example 1, and the solvent slurry method of Comparative Example 1. Inventive dry method LNMO cathodes were prepared with areal loadings of 3, 4, 6 and 9.5 mAh/cm². Comparative solvent slurry method LNMO cathodes were prepared with areal loadings of 3 and 4 mAh/cm².

Half-cell coin cell batteries were assembled using these cathodes, lithium metal anodes, Celgard 2325 separator and Gen 2 electrolyte (Gen 2 electrolyte is 1.0 M LiPF₆ in ethylene carbonate (EC) and ethylmethyl carbonate (EMC), EC:EMC ratio of 3:7 by weight). Full cell coin cell batteries were assembled with these cathodes, anode, Gen 2 electrolyte and Celgard 2325 separator. The anode is a graphite anode obtained from Ningbo Institute of Materials Technology and Engineering. The graphite used was artificial graphite and the weight percentage is 95%.

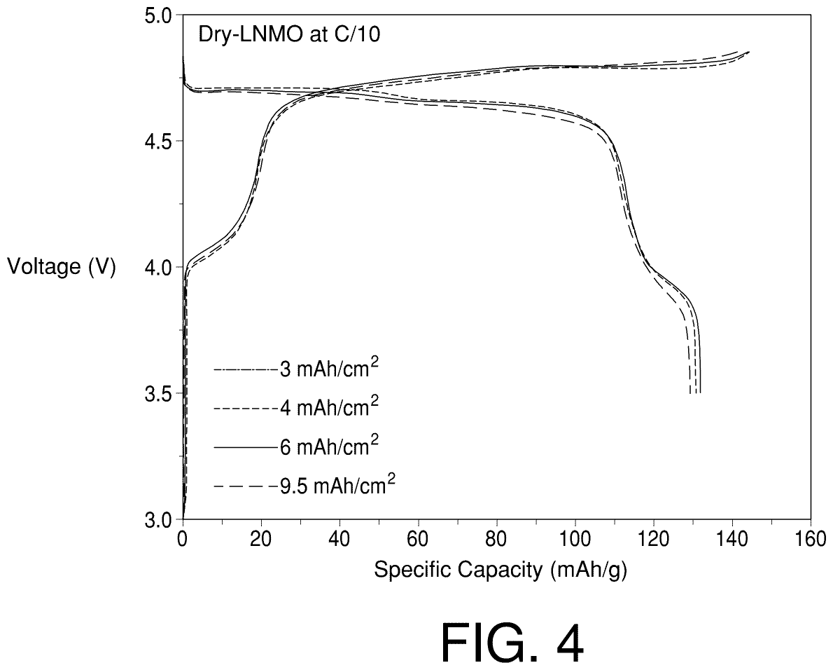

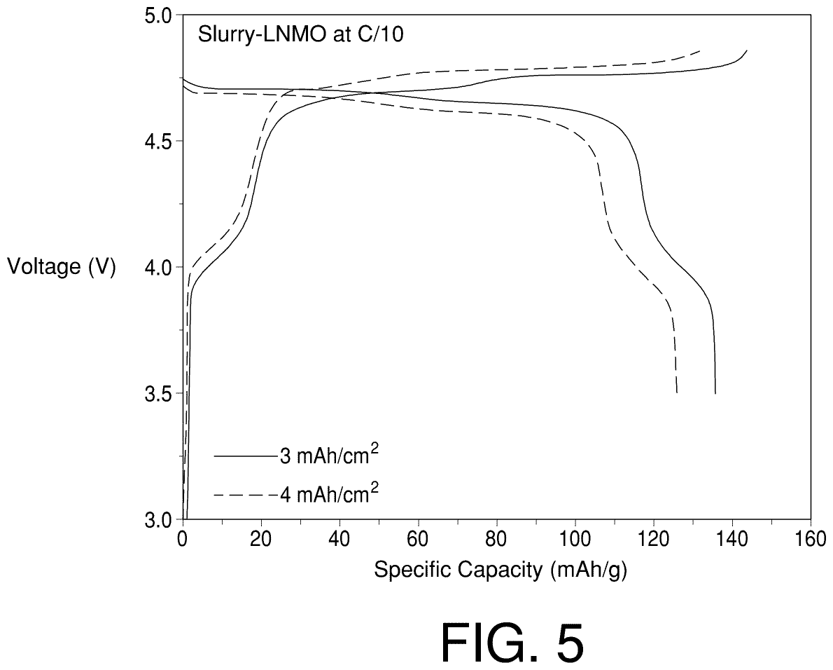

FIG. 4 is a plot of the C/10 rate half-cell performance (voltage (V)) vs specific capacity (mAh/g)) of half cell batteries using the inventive dry method LNMO cathodes having areal loadings of 3, 4, 6 and 9.5 mAh/cm². FIG. 5 is a plot of the C/10 rate half-cell performance (voltage (V)) vs specific capacity (mAh/g)) of half cell batteries using the comparative slurry method LNMO cathodes having areal loadings of 3 and 4 mAh/cm². The dry method LNMO half cell maintains consistently good performance even if the areal loading is tripled. On the other hand, slurry method LNMO shows significant performance decay when areal loading is increased to 4 mAh/cm². The present inventors believe excellent conductive carbon network has helped to achieve this performance.

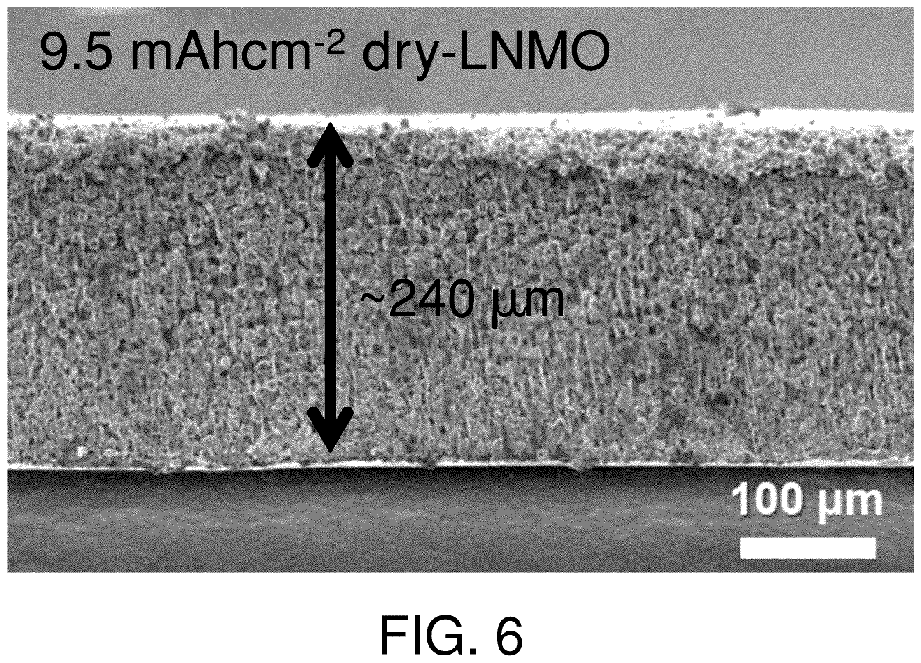

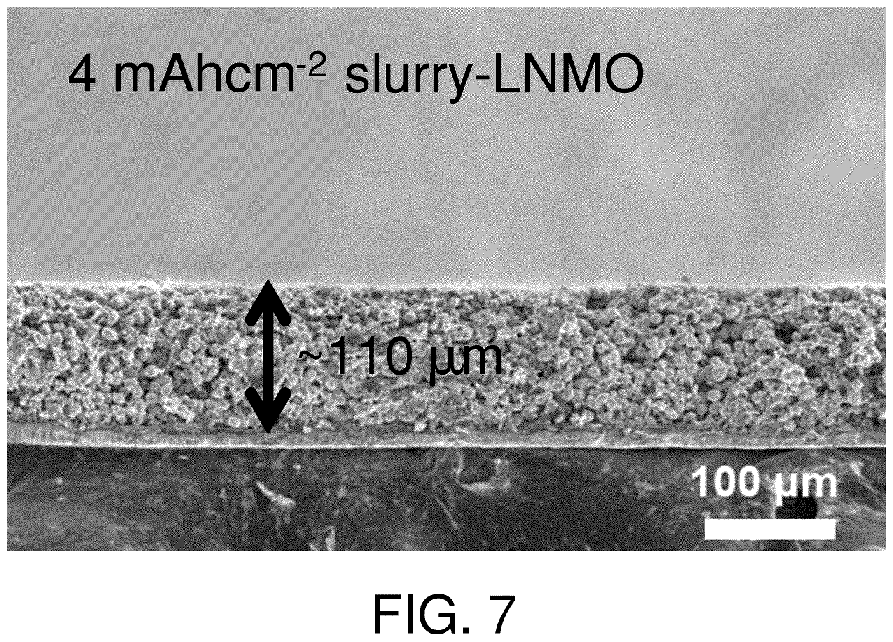

FIG. 6 is a cross sectional SEM image of a LNMO cathode made by the inventive dry method of present Example 1 having areal capacity of 9.5 mAh/cm², corresponding to thickness of ˜240 μm. FIG. 7 is a is a cross sectional SEM image of an LNMO cathode made by the comparative solvent slurry method of present comparative example 1 having areal capacity of 4 mAh/cm², corresponding to thickness of ˜110 μm. Dense electrode layer has been achieved in LNMO cathode made by the inventive dry method. No delamination is found between the electrode layer and current collector either.

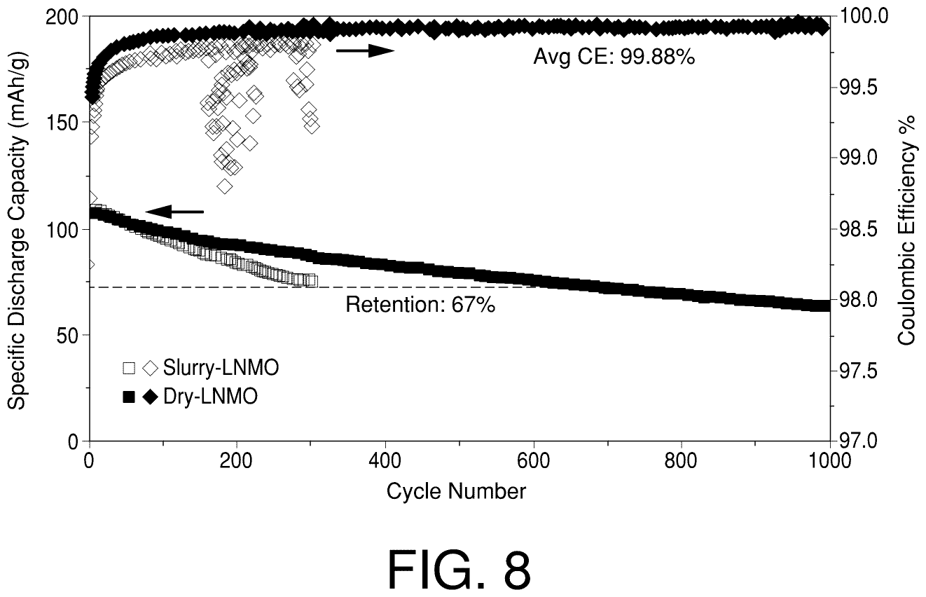

FIG. 8 is a plot showing a comparison of long-term cycling (through 1,000 cycles) of performance (specific capacity (mAh/g) and coulombic efficiency (%) vs cycle number) at C/3 rate of a full cell battery using an inventive dry method LMNO cathode and similar comparative full cell battery using a slurry method LMNO cathode, these cathodes having areal loading of 3 mAh/cm². Using the inventive dry method LNMO cathode resulted in a full cell battery with average coulombic efficiency of 99.88% over 1,000 cycles and 67% retention of specific discharge capacity through over 700 cycles. A similar full cell battery with a comparative slurry method LMNO cathode resulted in a comparative full cell battery suffering from significant reduction in coulombic efficiency and specific discharge capacity after only 300 cycles. The present inventors believe that reduction of low specific surface area and removal of carbon coating help to reduce parasitic reactions at high voltage.

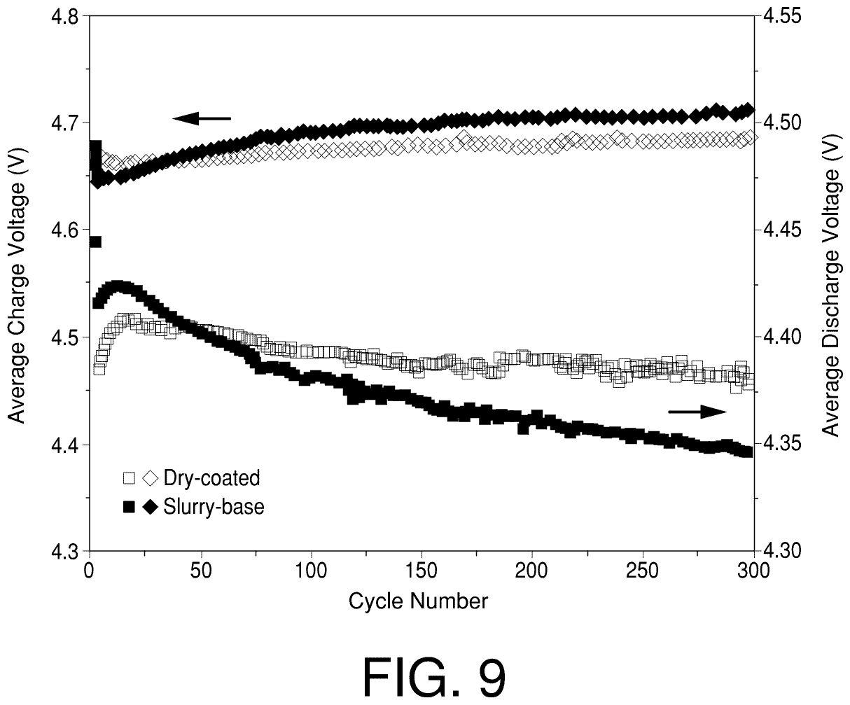

FIG. 9 is a plot showing the average charge voltage (V) and average discharge voltage (V) vs cycle number over 300 cycles for a full cell battery using an inventive dry method LMNO cathode, and a similar full cell battery using a slurry coated cathode, these cathodes having areal loading of 3 mAh/cm². The battery using the present inventive cathode shows relatively lower average charge voltage and relatively higher average discharge voltage over 300 cycles than a similar comparative full cell battery using a slurry coated cathode. Low and stable voltage hysteresis in the battery using the present inventive cathode show much slower impedance growth in the cells along cycling.

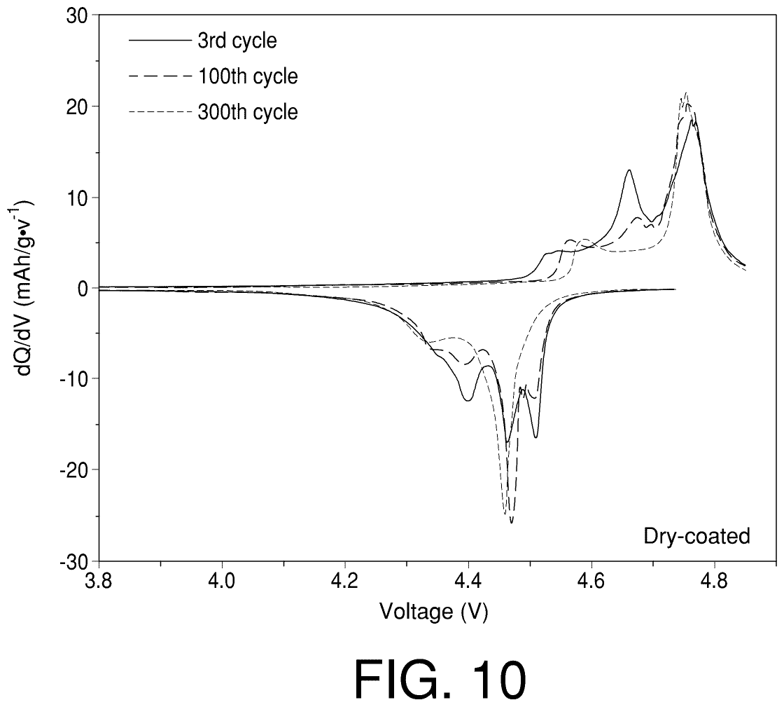

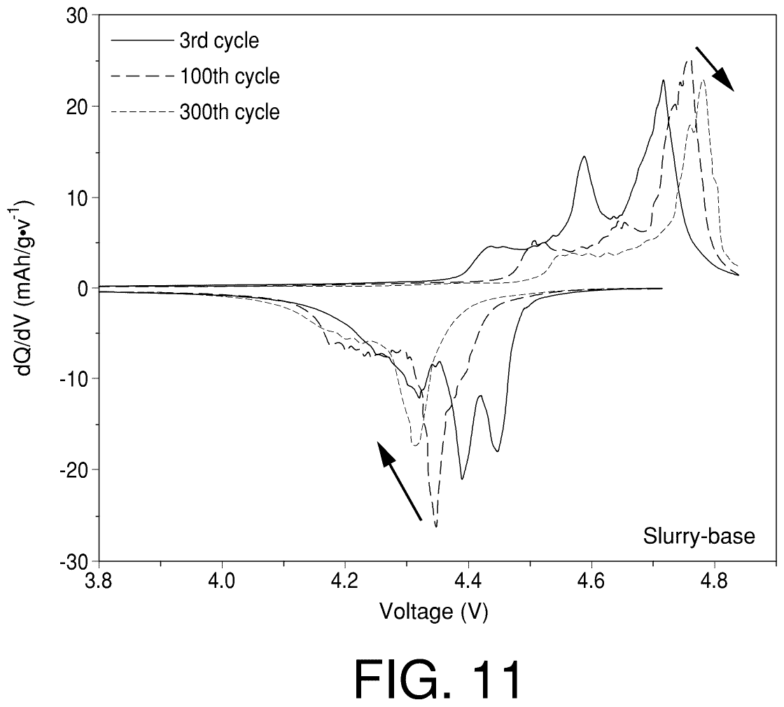

FIG. 10 is a dQ/dV plot (dQ/dV (mAh/g·v⁻¹) vs voltage (V)) for the full cell battery using the inventive dry method LMNO cathode. FIG. 11 is a dQ/dV plot (dQ/dV (mAh/g·v⁻¹) vs voltage (V)) for the full cell battery using the comparative slurry coated cathode, these cathodes having areal loading of 3 mAh/cm². The oxidative and reductive peak positions from full cell battery using the inventive dry method LMNO cathode are well maintained. These results indicate the dramatic impedance rising and severe Li inventory loss in the full cell using the comparative slurry coated cathode.

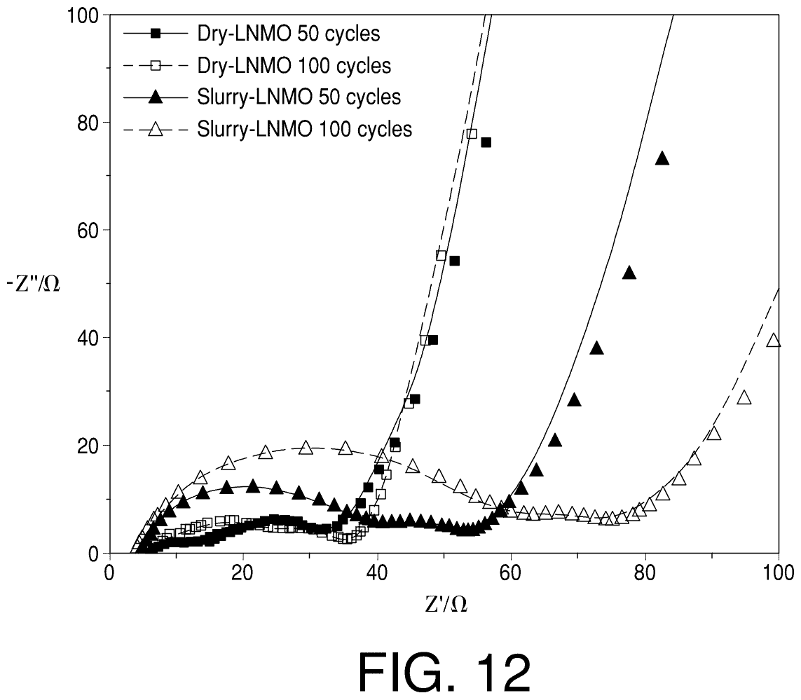

FIG. 12 is a Nyquist plot (−Z″/Ωvs Z′/Ω)) obtained by electrical impedance spectroscopy (EIS) for the full cell battery using the inventive dry method LMNO cathode, and the full cell battery using the comparative slurry coated cathode, after 50 and 100 cycles, these cathodes having areal loading of 3 mAh/cm². Significant impedance growth can even be observed in the full cell battery using the comparative slurry coated cathode in 100 cycles.

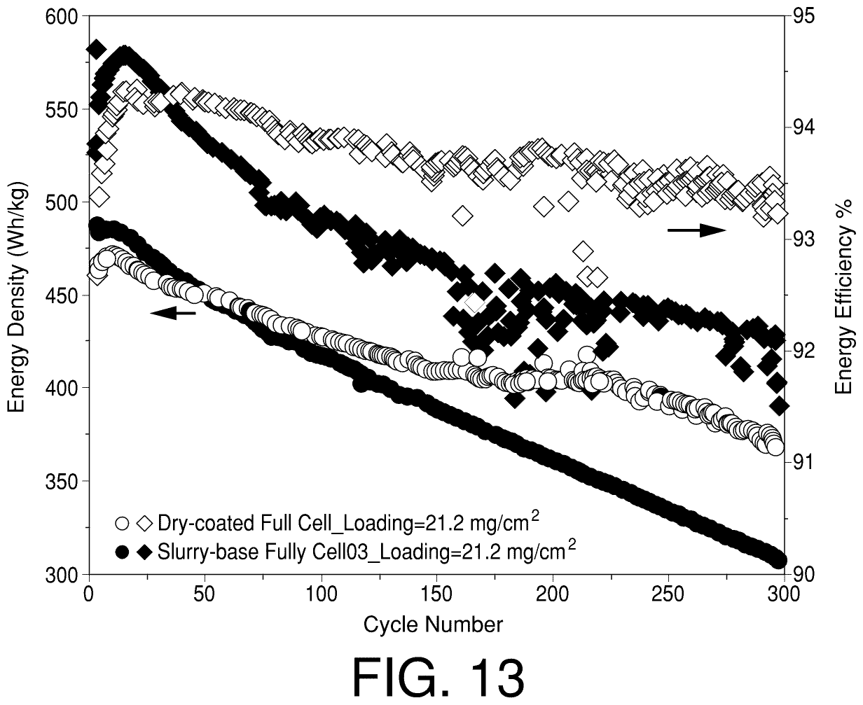

FIG. 13 is a plot showing the energy density (Wh/kg) and energy efficiency (%) vs cycle number over 300 cycles for a full cell battery using an inventive dry method LMNO cathode having LNMO loading of 21.2 mg/cm², and a similar full cell battery using a slurry coated cathode having LNMO loading of 21.2 mg/cm². Energy density level can be well maintained even after long cycling in the full cell battery using an inventive dry method LMNO cathode.

### Example 6—Electrochemical Performance of Full Cell Batteries Using Cathodes Made by the Inventive Dry Coating Method and Using Fluorinated Electrolyte

Cathodes using LNMO cathode active and having areal loading of 3 mAh/cm² were prepared according to the bottle roller dry method of Example 1.

Full cell batteries were assembled using these cathodes, graphite anodes, Dreamweaver Gold 20 separators, and in one example battery the electrolyte used is Gen 2 electrolyte (Gen 2 electrolyte is 1.0 M LiPF₆ in ethylene carbonate (EC) and ethylmethyl carbonate (EMC), EC:EMC ratio of 3:7 by weight), and in another example battery the electrolyte used is a fluorinated electrolyte referred to as FEC-FEMC (FEC-FEMC electrolyte is 1 M LiPF₆ in fluoroethylene carbonate (FEC) and methyl(2,2,2-trifluoroethyl) carbonate (FEMC), FEC:FEMC ratio of 1:9 by volume). The anode is a graphite anode obtained from Ningbo Institute of Materials Technology and Engineering. The graphite used was artificial graphite and the weight percentage is 95%.

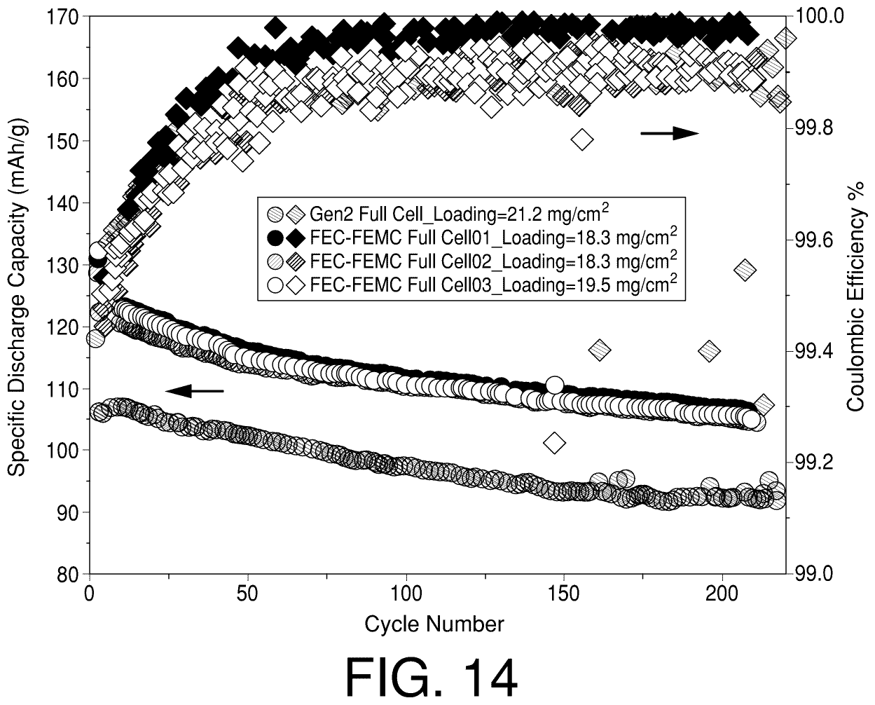

FIG. 14 is a plot showing a comparison of performance (specific discharge capacity (mAh/g) and coulombic efficiency (%) vs cycle number) for a full cell battery using an inventive dry method LNMO cathode using Gen 2 electrolyte, and an essentially identical full cell battery using FEC-FEMC electrolyte. A 99.9% Coulombic Efficiency can be reached in nearly 50 cycles. This cell system can be quickly stabilized in such high voltage operation.

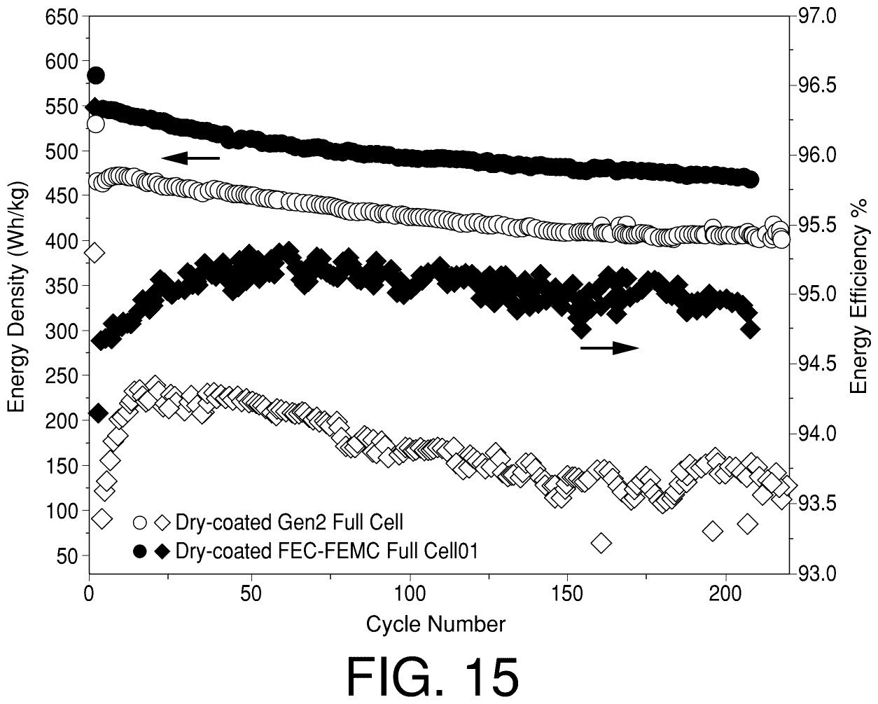

FIG. 15 is a plot showing the energy density (Wh/kg) and energy efficiency (%) vs cycle number over 200 cycles for a full cell battery using an inventive dry method LNMO cathode using Gen 2 electrolyte, and an essentially identical full cell battery using FEC-FEMC electrolyte. Energy density level can be well maintained even after long cycling in the full cell battery using an inventive dry method LMNO cathode with FEC-FEMC electrolyte.

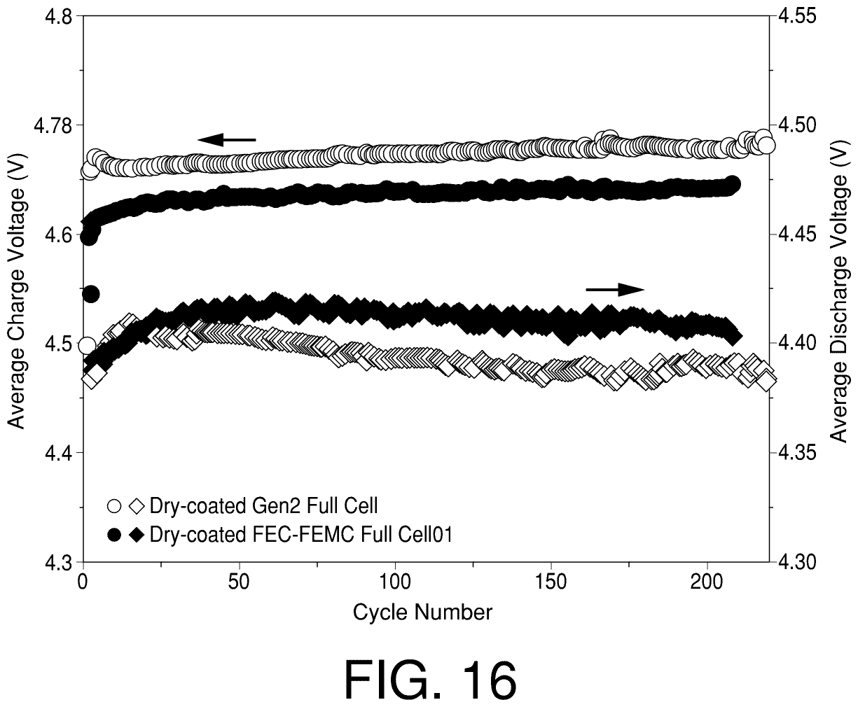

FIG. 16 is a plot showing the average charge voltage (V) and average discharge voltage (V) vs cycle number over 200 cycles for a full cell battery using an inventive dry method LNMO cathode using Gen 2 electrolyte, and an essentially identical full cell battery using FEC-FEMC electrolyte. Low and stable voltage hysteresis in the battery using the full cell battery using an inventive dry method LMNO cathode with FEC-FEMC electrolyte shows much slower impedance growth in the cells along cycling.

### Example 7—Electrochemical Performance of Full Cell Batteries Using Cathodes Made by the Inventive Dry Coating Method Adhered to Aluminum Current Collector with and without Carbon Coating

Cathodes using LNMO cathode active and having areal loading of 3 mAh/cm² were prepared according to mortar and pestle mixing method and calendaring method of Example 1. In one example embodiment a resultant cathode layer film was adhered to aluminum current collector having surface roughness of expressed as Sa (arithmetical mean height) of at least about 260 nm and having no carbon surface coating. The aluminum was from Tob New Energy, 20 um Etched Aluminum Foil for Supercapacitor. In a comparative example embodiment a resultant cathode layer film was adhered to a carbon coated aluminum current collector foil. The carbon coated aluminum current collector foil was Conductive Carbon Coated Aluminum Foil for Battery Cathode Substrate (260 mm W×18 um Thick, 80 m L/Roll), EQ-CC-AI-18u-260″ from MTI Corporation.

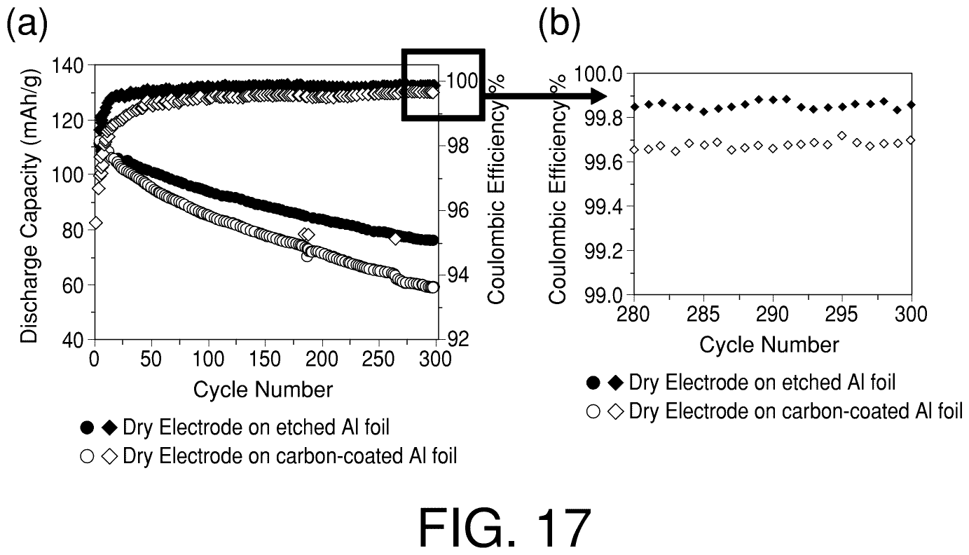

FIG. 17 is a plot of discharge capacity (mAh/g) and coulombic efficiency (%) vs cycle number for a full cell battery using an inventive dry method prepared LMNO cathode on a current collector comprising aluminum having substantially no carbon coating on the aluminum surface in contact with the electrode layer (other than the conductive carbon contained in the electrode layer), and a similar dry method prepared LMNO cathode on a current collector comprising aluminum having carbon coating.

It is evident from this experiment that carbon-coating on the current collector results in a very detrimental impact on the high voltage cycling performance in terms of Coulombic efficiency and capacity retention. When a current collector of the present invention comprising aluminum having substantially no carbon coating on the aluminum surface in contact with the electrode layer is used, the cycling stability is significantly improved.

What is claimed is:

1. A cathode for a high voltage lithium-ion secondary battery, comprising:
an electrode layer comprising an electrode composition comprising cathode active particles, fluoropolymer binder and conductive carbon, wherein:
said cathode active particles comprise lithium transition metal oxide having an electrochemical potential versus Li/Li+ of at least about 4.5 V;
said fluoropolymer binder is a tetrafluoroethylene polymer having a melt creep viscosity of at least about 1.8×10¹¹ poise;
said fluoropolymer binder is fibrillated;
said conductive carbon comprises carbon fibers having a specific surface area of about 50 m²/g or less,
said carbon fibers and said fibrillated fluoropolymer binder forming a conducting structural web electronically connecting said cathode active particles so as to enable electronic conductivity through the electrode layer, and wherein;
said electrode layer is adhered to a current collector comprising aluminum having surface roughness and substantially no carbon surface coating other than said conductive carbon of said electrode layer.

2. The cathode of claim 1, wherein said conducting structural web comprises at least one of:
A. a portion of said tetrafluoroethylene polymer and a portion of said carbon fibers in said web is combined in the form of conductive strands comprising a continuous tetrafluoroethylene polymer matrix and a plurality of carbon fibers, wherein said carbon fibers are embedded in and adhered to the tetrafluoroethylene polymer matrix comprising said strands, and wherein the longitudinal axis of said carbon fibers is substantially aligned with the longitudinal axis of said strands, and wherein said strands are randomly interwoven and interconnected throughout the volume between said cathode active particles, and are in contact with said cathode active particles;
B. a portion of said tetrafluoroethylene polymer and a portion of said carbon fibers in said web is combined in the form of discontinuous randomly matted regions located adjacent and attached to said cathode active particles, wherein said carbon fibers are embedded in and adhered to the tetrafluoroethylene polymer comprising said regions;
C. a portion of the tetrafluoroethylene polymer in said web is in the form of free tetrafluoroethylene polymer fibrils;
D. a portion of the tetrafluoroethylene polymer in said web is in the form of a tetrafluoroethylene polymer coating layer covering a portion of the surface of some of said cathode active particles; and
E. a portion of said carbon fibers in said web are free conductive carbon fibers; and
wherein said conductive strands (A.), said discontinuous random matted regions (B.), said free fluoropolymer fibrils (C.), said tetrafluoroethylene polymer coating layers (D.), and said free conductive carbon fibers (E.) are randomly interconnected with one another throughout said electrode layer, and are in contact with the surface of said cathode active particles, thereby forming said conducting structural web electrically connecting and securing in place said cathode particles.

3. The cathode of claim 1, wherein said electrode composition contains from about 1 to about 10 weight percent conductive carbon, about 0.5 to about 5 weight percent fluoropolymer binder, and the remainder cathode active particles, based on the combined weight of said fluoropolymer binder, said cathode active particles, and said conductive carbon.

4. The cathode of claim 1, wherein said electrode composition contains from about 2 to about 7 weight percent conductive carbon, about 1 to about 3 weight percent fluoropolymer binder, and the remainder cathode active particles, based on the combined weight of said fluoropolymer binder, said cathode active particles, and said conductive carbon.

5. The cathode of claim 1, wherein said electrode composition contains about 5 weight percent conductive carbon, about 2 weight percent fluoropolymer binder, and the remainder cathode active particles, based on the combined weight of said fluoropolymer binder, said cathode active particles, and said conductive carbon.

6. The cathode of claim 1, wherein said carbon fibers have a length of from about 10 micrometers to about 200 micrometers.

7. The cathode of claim 1, wherein said conductive carbon has a specific surface area of about 40 m²/g or less.

8. The cathode of claim 1, wherein said conductive carbon has a specific surface area of about 30 m²/g or less.

9. The cathode of claim 1, wherein said conductive carbon has a specific surface area of about 20 m²/g or less.

10. The cathode of claim 1, wherein said electrode layer is substantially free from conductive carbon having a specific surface area greater than about 50 m²/g.

11. The cathode of claim 7, wherein said electrode layer is substantially free from conductive carbon having a specific surface area greater than about 40 m²/g.

12. The cathode of claim 8, wherein said electrode layer is substantially free from conductive carbon having a specific surface area greater than about 30 m²/g.

13. The cathode of claim 9, wherein said electrode layer is substantially free from conductive carbon having a specific surface area greater than about 20 m²/g.

14. The composition of claim 1, wherein said tetrafluoroethylene polymer has a melt creep viscosity of at least about 2.0×10¹¹ poise.

15. The of claim 1, wherein said tetrafluoroethylene polymer has a melt creep viscosity of at least about 3.0×10¹¹ poise.

16. The of claim 1, wherein said tetrafluoroethylene polymer has a melt creep viscosity of at least about 4.0×10¹¹ poise.

17. The cathode of claim 1, wherein said electrode layer is formed by a process free from solvent.

18. The cathode of claim 1, wherein said electrode layer is formed by dry mixing said cathode active particles, fluoropolymer binder and conductive carbon to form said electrode composition, and applying a shear force to said electrode composition in the absence of solvent to form said electrode layer.

19. The cathode of claim 1, wherein said conductive carbon fibers have a diameter of from about 0.1 micrometers to about 0.2 micrometers.

20. The cathode of claim 1, wherein said conductive carbon fibers comprise vapor grown carbon fibers (VGCF).

21. The cathode of claim 1, wherein said lithium transition metal oxide has an electrochemical potential versus Li/Li+ of at least about 4.6 V.

22. The cathode of claim 1, wherein said lithium transition metal oxide is selected from the group consisting of LiNiₓMn₂₋ₓ O₄ (LNMO) and Li_{1.098}Mn_{0.533}Ni_{0.113}Co_{0.13802} (Li-rich layered oxide (LRLO)).

23. The cathode of claim 1, wherein said lithium transition metal oxide is selected from the group consisting of LiNi_{0.5}Mn_{1.5}O₄, LiNi_{0.45}Mn_{1.45}Cr_{0.104}, LiCr_{0.5}Mn_{1.5}O₄, LiCrMnO₄, LiCu_{0.5}Mn_{1.5}O₄, LiCoMnO₄, LiFeMnO₄, LiNiVO₄, LiNiPO₄, LiCoPO₄ and Li₂CoPO₄F.

24. The cathode of claim 1, wherein said fluoropolymer binder is fibrillated such that said electrode layer is self-supporting.

25. The cathode of claim 1, wherein the surface roughness of said aluminum current collector expressed as Sa (arithmetical mean height) is at least about 260 nm.

26. The cathode of claim 1, wherein the surface roughness of said aluminum current collector expressed as Sa (arithmetical mean height) is at least about 280 nm.

27. The cathode of claim 1, wherein the surface roughness of said aluminum current collector expressed as Sa (arithmetical mean height) is at least about 300 nm.

28. The cathode of claim 1, wherein the thickness of said electrode layer is from about 60 micrometers to about 250 micrometers.

29. The cathode of claim 1, wherein the thickness of said electrode layer is from about 80 micrometers to about 120 micrometers.

30. The cathode of claim 1, wherein the thickness of said electrode layer is at least about 240 micrometers.

31. The cathode of claim 1, wherein:
the thickness of said electrode layer is at least about 80 micrometers; and the 2-point probe conductivity is at least about 1×10⁻² S/cm, and the 4-point probe conductivity is at least about 1×10⁻² S/cm.

32. The cathode of claim 1, wherein:
the thickness of said electrode layer is at least about 100 micrometers; and the 2-point probe conductivity is at least about 1×10⁻² S/cm, and the 4-point probe conductivity is at least about 1×10⁻² S/cm.

33. The cathode of claim 1, wherein:
the thickness of said electrode layer is at least about 130 micrometers; and the 2-point probe conductivity is at least about 1×10⁻² S/cm, and the 4-point probe conductivity is at least about 1×10⁻² S/cm.

34. A high voltage lithium-ion secondary battery comprising:
a cathode comprising: an electrode layer comprising an electrode composition comprising cathode active particles, fluoropolymer binder and conductive carbon, wherein: said cathode active particles comprise lithium transition metal oxide having an electrochemical potential versus Li/Li+ of at least about 4.5 V; said fluoropolymer binder is a tetrafluoroethylene polymer having a melt creep viscosity of at least about 1.8×10¹¹ poise; said fluoropolymer binder is fibrillated; said conductive carbon comprises carbon fibers having a specific surface area of about 50 m²/g or less, said carbon fibers and said fibrillated fluoropolymer binder forming a conducting structural web electronically connecting said cathode active particles so as to enable electronic conductivity through the electrode layer, and wherein; said electrode layer is adhered to a current collector comprising aluminum having surface roughness and substantially no carbon surface coating other than said conductive carbon of said electrode layer;
an anode;
a separator between said cathode and said anode; and
an electrolyte in communication with said cathode, anode and separator.

35. The lithium-ion secondary battery of claim 34, wherein said carbon fibers have a length of from about 10 micrometers to about 200 micrometers.

36. The lithium-ion secondary battery of claim 34, wherein
said anode is a graphite anode comprising from about 80% active material with a specific capacity of at least about 300 mAh/g at a discharge rate of at least about C/20, and has a loading level of anode active material that is at least about 5 mg/cm², and wherein
the cathode has a loading level of cathode active material on said current collector that is at least about 10 mg/cm²,
wherein following activation of the battery in a first charge cycle the negative electrode has a specific discharge capacity of at least about 300 mAh/g based on the weight of the negative electrode active material at a rate of at least about C/20,
and the battery has a discharge energy density of at least about 260 Wh/kg at a rate of at least about C/20, and wherein
the battery has a discharge energy density at the 100th charge-discharge cycle of at least about 90% of the discharge energy density at the third cycle.

37. The lithium-ion secondary battery of claim 34, wherein said anode is a pure silicon anode and the battery has a discharge energy density of at least about 300 Wh/kg at a rate of at least about C/20, and wherein the battery has a discharge energy density at the 100th charge-discharge cycle of at least about 90% of the discharge energy density at the third cycle.

38. The lithium-ion secondary battery of claim 34, wherein said anode is a lithium metal anode and the battery has a discharge energy density of at least about 340 Wh/kg at a rate of at least about C/20, and wherein the battery has a discharge energy density at the 100th charge-discharge cycle of at least about 90% of the discharge energy density at the third cycle.

39. The lithium-ion secondary battery of claim 34, wherein said battery has an energy density of at least about 350 Wh/kg at a rate of at least about C/20.

40. The lithium-ion secondary battery of claim 34, wherein said battery has an energy density of at least about 400 Wh/kg at a rate of at least about C/20.

41. The lithium-ion secondary battery of claim 34, wherein said battery has an energy density of at least about 450 Wh/kg at a rate of at least about C/20.

42. The lithium-ion secondary battery of claim 34, wherein said battery has an energy density of at least about 500 Wh/kg at a rate of at least about C/20.

43. The lithium-ion secondary battery of claim 34, wherein said electrolyte comprises a fluorinated organic solvent.

44. The lithium-ion secondary battery of claim 43, wherein said electrolyte comprises a fluorinated organic solvent selected from the group consisting of fluoroethylene carbonate (FEC) and methyl(2,2,2-trifluoroethyl) carbonate (FEMC).

45. A method for manufacturing a cathode for use in a high voltage lithium-ion secondary battery, comprising:
I.) dry milling a mixture of:
i) conductive carbon, comprising carbon fibers having a specific surface area of about 50 m²/g or less;
ii) cathode active particles comprising lithium transition metal oxide having an electrochemical potential versus Li/Li+ of at least about 4.5 V; and
iii) fluoropolymer binder comprising tetrafluoroethylene polymer
having a melt creep viscosity of at least about 1.8×10¹¹ poise, to form a powdered dry cathode mixture, wherein said dry milling fibrillates said fluoropolymer binder and forms a conducting structural web comprising said fluoropolymer binder and said conductive carbon, said conducting structural web electronically connecting said cathode active particles so as to enable electronic conductivity throughout said cathode;
II.) calendaring said powdered dry cathode mixture to form a dry cathode electrode layer, and;
III.) adhering said dry cathode electrode layer to a current collector comprising aluminum having surface roughness and substantially no carbon surface coating other than said conductive carbon of said cathode electrode layer.

46. The method of claim 45, wherein said carbon fibers have a length of from about 10 micrometers to about 200 micrometers.

47. The method of claim 45, wherein said dry milling substantially homogeneously distributes said carbon fibers and said fluoropolymer binder with said cathode active particles.

48. The method of claim 45, wherein said carbon fibers subjected to said dry milling are in the form of agglomerates, and said dry milling is sufficient to substantially deagglomerate said agglomerates resulting in singular carbon fibers and relatively small clusters of carbon fibers.

49. The method of claim 48, wherein said dry milling further comprises:
dry milling under first conditions a mixture comprising said agglomerates of carbon fibers and said cathode active particles, resulting a first dry mixture;
combining said fluoropolymer binder and said first dry mixture to form a second dry mixture; and
dry milling under second conditions said second dry mixture.

50. The method of any of claims 45 through 49, wherein said dry milling is carried out at a temperature of from about 40° C. to about 150° C.

51. The method of any of claims 45 through 49, where said dry milling is carried out by application of shear.

52. The method of any of claims 45 through 49, where said dry mixing is carried out in a bottle roller.

53. The method of any of claims 45 through 49, wherein said dry mixing comprises application of shear force such that said fluoropolymer binder is fibrillated and said carbon fibers are substantially unbroken and are homogeneously distributed throughout said powdered dry cathode mixture.

54. The method of claim 45, where said calendaring is carried out at a temperature of from about 70° C. to about 200° C.

55. The method of claim 45, where said calendaring is carried out under an applied pressure of about 1 metric ton to about 10 metric tons.

56. The method of claim 45, carried out free from solvent.

57. An electrically conducting structural web interconnecting electrically conductive particles, comprising:
carbon fibers and tetrafluoroethylene polymer having a melt creep viscosity of at least about 1.8×10¹¹ poise;
said carbon fibers and said tetrafluoroethylene polymer combined in the form of a conducting structural web electronically connecting said electrically conductive particles so as to enable structural reinforcement and electrical conductivity through a solid structure comprising said electrically conductive particles;
wherein a portion of said tetrafluoroethylene polymer and a portion of said carbon fibers in said web is a composite in the form of (A.) electrically conductive reinforcing strands comprising a continuous tetrafluoroethylene polymer matrix and a plurality of carbon fibers,
wherein said carbon fibers are embedded in and adhered to the tetrafluoroethylene polymer matrix comprising said strands, and
wherein the longitudinal axis of said carbon fibers is substantially aligned with the longitudinal axis of said strands, and
wherein said strands are randomly interwoven and interconnected throughout the volume in between said electrically conductive particles comprising said solid structure, and said strands are in contact with said electrically conductive particles.

58. The electrically conducting structural web of claim 57, wherein said conducting structural web further comprises at least one of:
B. a portion of said tetrafluoroethylene polymer and a portion of said carbon fibers in said web is combined in the form of discontinuous randomly matted regions located adjacent to and attached to said electrically conductive particles, wherein said carbon fibers are embedded in and adhered to the tetrafluoroethylene polymer comprising said regions;
C. a portion of the tetrafluoroethylene polymer in said web is in the form of free tetrafluoroethylene polymer fibrils;
D. a portion of the tetrafluoroethylene polymer in said web is in the form of a tetrafluoroethylene polymer coating layer covering a portion of the surface of some of said electrically conductive particles; and
E. a portion of said carbon fibers in said web are free conductive carbon fibers; and
wherein said electrically conductive reinforcing strands (A.), said discontinuous random matted regions (B.), said free fluoropolymer fibrils (C.), said tetrafluoroethylene polymer coating layers (D.), and said free conductive carbon fibers (E.) are randomly interconnected with one another throughout said electrically conducting structural web, and are in contact with the surface of said electrically conductive particles, thereby forming said conducting structural web electrically connecting and securing in place said electrically conductive particles.

59. The electrically conducting structural web of claim 57, wherein said carbon fibers have a specific surface area of about 50 m²/g or less.

60. The electrically conducting structural web of claim 57, wherein said carbon fibers have a length of from about 10 micrometers to about 200 micrometers.

61. The electrically conducting structural web of claim 57, wherein said carbon fibers have a specific surface area of about 40 m²/g or less.

62. The electrically conducting structural web of claim 57, wherein said carbon fibers have a specific surface area of about 30 m²/g or less.

63. The electrically conducting structural web of claim 57, wherein said carbon fibers have a specific surface area of about 20 m²/g or less.

64. The electrically conducting structural web of claim 57, wherein said tetrafluoroethylene polymer has a melt creep viscosity of at least about 2.0×10¹¹ poise.

65. The electrically conducting structural web of claim 57, wherein said tetrafluoroethylene polymer has a melt creep viscosity of at least about 3.0×10¹¹ poise.

66. The electrically conducting structural web of claim 57, wherein said tetrafluoroethylene polymer has a melt creep viscosity of at least about 4.0×10¹¹ poise.

67. The electrically conducting structural web of claim 57, formed by a process free from solvent.

68. The electrically conducting structural web of claim 57, formed by dry mixing said particles, tetrafluoroethylene polymer and conductive carbon to form an electrode composition, and applying a shear force to said electrode composition in the absence of solvent to form said electrically conducting structural web.

69. The electrically conducting structural web of claim 57, wherein said conductive carbon fibers have a diameter of from about 0.1 micrometers to about 0.2 micrometers.

70. The electrically conducting structural web of claim 57, wherein said conductive carbon fibers comprise vapor grown carbon fibers (VGCF).

71. The electrically conducting structural web of claim 57, wherein said particles are active particles comprising lithium transition metal oxide having an electrochemical potential versus Li/Li+ of at least about 4.6 V.

72. The electrically conducting structural web of claim 57, wherein said lithium transition metal oxide is selected from the group consisting of LiNiₓMn₂₋ₓ O₄ (LNMO) and Li_{1.098}Mn_{0.533}Ni_{0.113}Co_{0.138}O₂ (Li-rich layered oxide (LRLO)).

73. The electrically conducting structural web of claim 57, wherein said lithium transition metal oxide is selected from the group consisting of LiNi_{0.5}Mn_{1.5}O₄, LiNi_{0.45}Mn_{1.45}Cr_{0.1}O₄, LiCr_{0.5}Mn_{1.5}O₄, LiCrMnO₄, LiCu_{0.5}Mn_{1.5}O₄, LiCoMnO₄, LiFeMnO₄, LiNiVO₄, LiNiPO₄, LiCoPO₄ and Li₂CoPO₄F.

74. The electrically conducting structural web of claim 57, wherein said tetrafluoroethylene polymer is fibrillated such that said electrically conducting structural web is self-supporting.

75. The electrically conducting structural web of claim 57, wherein the thickness of said electrically conducting structural web is from about 60 micrometers to about 250 micrometers.

76. The electrically conducting structural web of claim 57, wherein the thickness of said electrically conducting structural web is from about 80 micrometers to about 120 micrometers.

77. The electrically conducting structural web of claim 57, wherein the thickness of said electrically conducting structural web is at least about 240 micrometers.
